(19) United States
(12) Patent Application Publication
(10) Pub. No.: US 2008/0230950 A1
(43) Pub. Date: Sep. 25, 2008

(54) RESIN SEALING METHOD, MOLD FOR RESIN SEALING, AND RESIN SEALING APPARATUS

(75) Inventors: Takao NISHIMURA, Kawasaki (JP); Kazunari KOSAKAI, Aizuwakamatsu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/049,616

(22) Filed: Mar. 17, 2008

(30) Foreign Application Priority Data
Mar. 19, 2007 (JP) 2007-071619

(51) Int. Cl. B29C 45/16; B29C 45/14; B29C 45/32

(52) U.S. Cl. 264/277; 264/275; 425/125

(57) ABSTRACT

A resin sealing method includes the steps of providing an intermediate mold between an upper mold and a lower mold, the intermediate mold having a cavity forming part where a resin sealed part is received; and introducing sealing resin into the cavity forming part of the intermediate mold and another main surface of the intermediate mold via a runner, the runner being provided in a vicinity of the cavity forming part of the intermediate mold and piercing the intermediate mold in a thickness direction.

### BACKGROUND OF THE INVENTION

1. Field of the Invention

The present invention generally relates to resin sealing methods, molds for resin sealing, and resin sealing apparatuses. More specifically, the present invention relates to a resin sealing method of an electronic component, and a mold and a resin sealing apparatus used for the resin sealing method, wherein at least one of surfaces of a sheet member such as a lead frame or a wiring board where an electronic component such as a semiconductor element is mounted is sealed by molten resin.

2. Description of the Related Art

Conventionally, a resin sealing method is applied as one of sealing methods for sealing a semiconductor element (electronic component) mounted on a sheet member such as a lead frame or a wiring board in order to form a semiconductor device. As the resin sealing method, a so-called transfer mold method is used.

In the transfer mold method, the sheet member such as the wiring board or the lead frame is sandwiched by an upper mold and a lower mold. A semiconductor element mounted on the sheet member, a bonding wire configured to connect an outside connection terminal of the semiconductor element and an electrode terminal on the wiring board or the lead frame to each other, and others are provided in a cavity forming part formed in at least one of the upper mold and the lower mold. Molten resin is injected (supplied) into the cavity forming part so that resin sealing is done.

In this method, in order to improve manufacturing efficiency, plural semiconductor elements are mounted on the sheet member and sealed in a single sealing step in a lump.

More specifically, a method wherein plural sheet members are horizontally provided in large upper and lower molds and the sheet members are processed in a lump is applied. Alternatively, a method where a large number of semiconductor elements are mounted on a single large sheet member is applied.

For example, a resin sealing method of an electronic component is suggested in Japan Laid-Open Patent Application Publication No. 11-340263. In this method, two sheet members are bonded on the sides, on which electronic components are not attached. While two sheet members are bonded on the sides, on which the electronic components are not attached, the electronic components are engaged inside cavities respectively provided in the resin-encapsulating mold comprising a fixed mold and a movable mold. A melting resin material is injected into and fills the cavities at the same time.

According to the method suggested in Japan Laid-Open Patent Application Publication No. 11-340263, since resin sealing is performed in a state where two sheet members are stacked, it is possible to improve productivity approximately two times in a single sealing step without increasing an area of a mold where the sheet members are provided.

However, in a case where plural sheet members are horizontally provided in large upper and lower molds and the sheet members are processed in a lump, large sizes of the upper and lower molds cause an increase of a pressing pressure of the molds and a large size of the resin sealing apparatus. This may cause an increase of manufacturing cost.

In a case where a large number of semiconductor elements are mounted on a single large sheet member, the large size of the sheet member causes an increase of curvature of the sheet member. This may cause degradation of yield rate.

Furthermore, according to the method described in Japan Laid-Open Patent Application Publication No. 11-340263, only a single surface of the sheet member where an electronic component is mounted is sealed by resin. Accordingly, the method described in Japan Laid-Open Patent Application Publication No. 11-340263 cannot be applied to resin sealing of both surfaces of the sheet member, for example resin sealing of a semiconductor package such as a QFP (Quad Flat Package) or a SOP (Small Outline Package).

### SUMMARY OF THE INVENTION

According to one aspect of an embodiment, a resin sealing method including the steps of: providing an intermediate mold between an upper mold and a lower mold, the intermediate mold having a cavity forming part where a resin sealed part is received; and introducing sealing resin into the cavity forming part of the intermediate mold and another main surface of the intermediate mold via a runner, the runner being provided in a vicinity of the cavity forming part of the intermediate mold and piercing the intermediate mold in a thickness direction is provided.

According to another aspect of the embodiment, a resin sealing method including the steps of providing a plurality of the intermediate molds between an upper mold and a lower mold, the intermediate molds having cavity forming parts where resin sealed parts are received; and introducing sealing resin into the cavity forming part of each of the intermediate molds via a runner, the runner being provided in the vicinities of the cavity forming parts of the stacked intermediate molds and piercing the intermediate molds in a stacking direction is provided.

According to other aspect of the embodiment, a mold for resin sealing, including an upper mold; a lower mold; and at least one intermediate mold provided between the upper mold and the lower mold; wherein the intermediate mold includes a cavity forming part formed in at least one of main surfaces of the intermediate mold and configured to receive a resin sealed part; and a runner provided in the vicinity of the cavity forming part and piercing the intermediate mold in a thickness direction is provided.

According to other aspect of the embodiment, a resin sealing apparatus, including an upper mold; a lower mold; and at least one intermediate mold provided between the upper mold and the lower mold; wherein the intermediate mold includes a cavity forming part formed in at least one of main surfaces of the intermediate mold and configured to receive a resin sealed part; and a runner provided in the vicinity of the cavity forming part and piercing the intermediate mold in a thickness direction is provided.

### BRIEF DESCRIPTION OF THE DRAWINGS

FIG. 1 is a schematic cross-sectional view of a mold for resin sealing provided in a resin sealing apparatus used for a resin sealing method of an electronic component of a first embodiment of the present invention;

FIG. 2 is a plan view of an upper mold 1 shown in FIG. 1;

FIG. 3 is a plan view of a second intermediate mold 4 shown in FIG. 1;

FIG. 4 is a plan view of a first intermediate mold 3 shown in FIG. 1;

FIG. 5 is a plan view of a lower mold 2 shown in FIG. 1;

FIG. 6 is a first view for explaining a resin sealing method using the mold 10 for resin sealing shown in FIG. 1;

FIG. 7 is a second view for explaining the resin sealing method using the mold 10 for resin sealing shown in FIG. 1;

FIG. 8 is a third view for explaining the resin sealing method using the mold 10 for resin sealing shown in FIG. 1;

FIG. 9 is a fourth view for explaining the resin sealing method using the mold 10 for resin sealing shown in FIG. 1;

FIG. 10 is a fifth view for explaining the resin sealing method using the mold 10 for resin sealing shown in FIG. 1;

FIG. 11 is a sixth view for explaining the resin sealing method using the mold 10 for resin sealing shown in FIG. 1;

FIG. 12 is a seventh view for explaining the resin sealing method using the mold 10 for resin sealing shown in FIG. 1;

FIG. 13 is a first schematic cross-sectional view of a mold for resin sealing provided in a resin sealing apparatus used for a resin sealing method of an electronic component of a second embodiment of the present invention;

FIG. 14 is a second schematic cross-sectional view of a mold for resin sealing provided in a resin sealing apparatus used for a resin sealing method of an electronic component of the second embodiment of the present invention;

FIG. 15 is a third schematic cross-sectional view of a mold for resin sealing provided in a resin sealing apparatus used for a resin sealing method of an electronic component of the second embodiment of the present invention;

FIG. 16 is a plan view of an upper mold 61 shown in FIG. 13 through FIG. 15;

FIG. 17 is a plan view of a second intermediate mold 64 shown in FIG. 13 through FIG. 15;

FIG. 18 is a plan view of a first intermediate mold 63 shown in FIG. 13 through FIG. 15;

FIG. 19 is a plan view of a lower mold 62 shown in FIG. 13 through FIG. 15;

FIG. 20 is a cross-sectional view taken along a line D-D of FIG. 16 through FIG. 19;

FIG. 21 is a schematic cross-sectional view of a mold for resin sealing provided in a resin sealing apparatus used for a resin sealing method of an electronic component of a third embodiment of the present invention;

FIG. 22 is a plan view of an intermediate mold 103 shown in FIG. 21;

FIG. 23 is a schematic cross-sectional view of a mold for resin sealing provided in a resin sealing apparatus used for a resin sealing method of an electronic component of a fourth embodiment of the present invention;

FIG. 24 is a plan view of a lead frame where semiconductor elements are mounted used in a fifth embodiment of the present invention;

FIG. 25 is a schematic cross-sectional view of a mold for resin sealing provided in a resin sealing apparatus used for a resin sealing method of an electronic component of the fifth embodiment of the present invention;

FIG. 26 is a plan view of an upper mold 251 shown in FIG. 25;

FIG. 27 is a plan view of a first intermediate mold 254 shown in FIG. 25;

FIG. 28 is a plan view of a second intermediate mold 253 shown in FIG. 25;

FIG. 29 is a plan view of a lower mold 252 shown in FIG. 25;

FIG. 30 is a view for explaining a structure of an eject mechanism using an eject pin 300;

FIG. 31 is a first view for explaining a resin sealing method using the mold 250 for resin sealing shown in FIG. 25;

FIG. 32 is a second view for explaining the resin sealing method using the mold 250 for resin sealing shown in FIG. 25;

FIG. 33 is a third view for explaining the resin sealing method using the mold 250 for resin sealing shown in FIG. 25; and

FIG. 34 is a fourth view for explaining the resin sealing method using the mold 250 for resin sealing shown in FIG. 25.

### DETAILED DESCRIPTION OF THE PREFERRED EMBODIMENTS

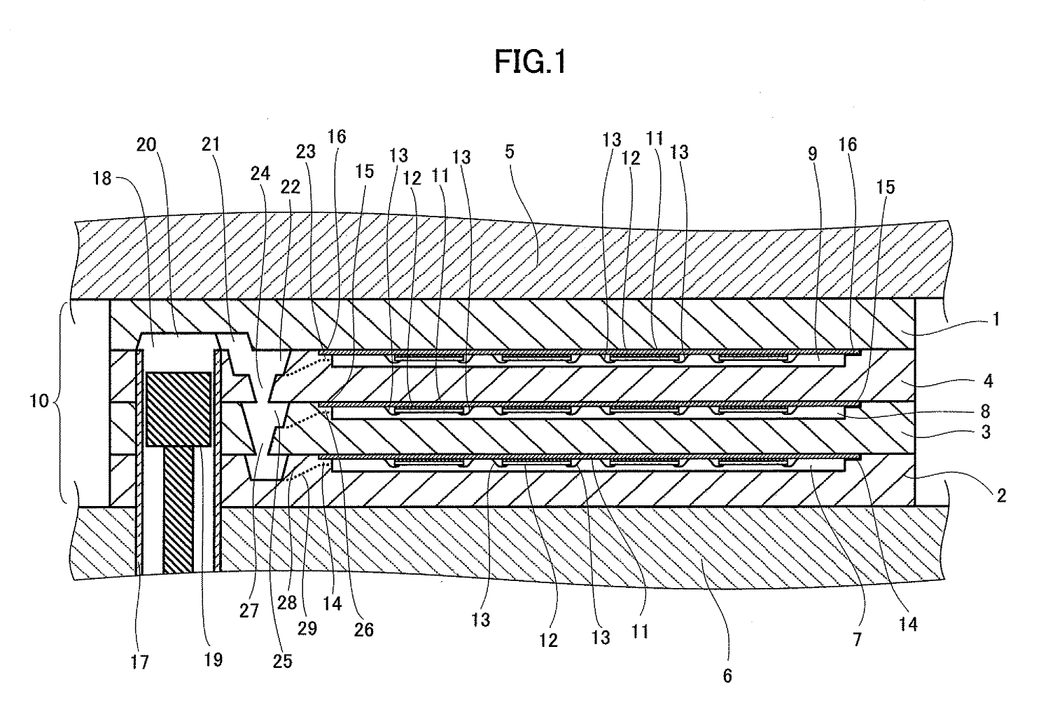

A description is given below, with reference to the FIG. 1 through FIG. 34 of embodiments of the present invention.

### First Embodiment

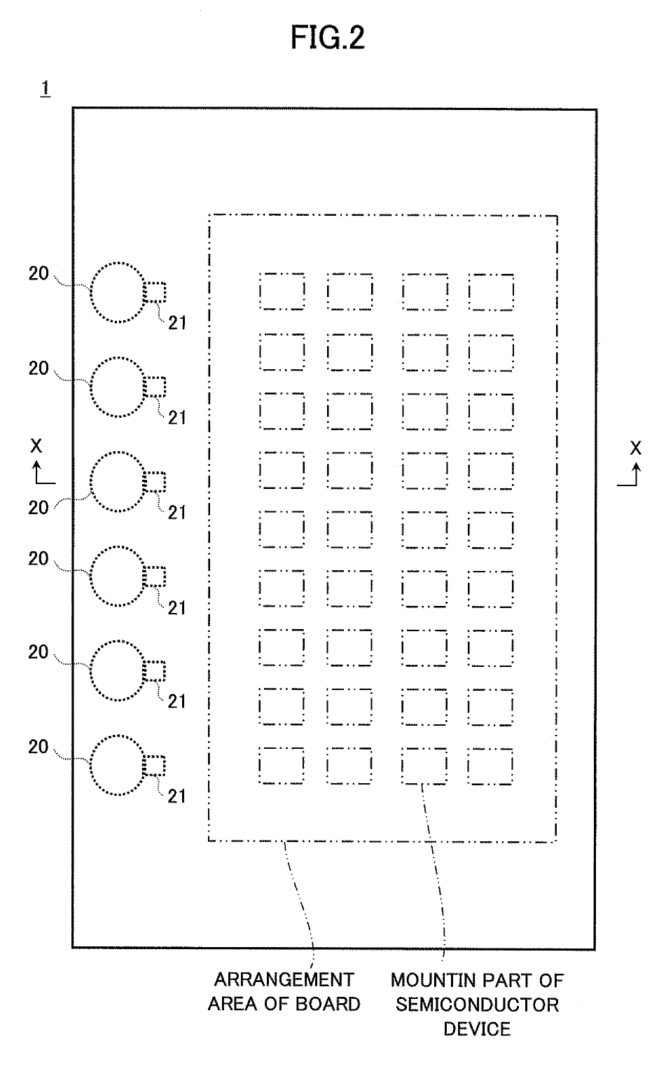

FIG. 1 is a schematic cross-sectional view of a mold for resin sealing provided in a resin sealing apparatus used for a resin sealing method of an electronic component of a first embodiment of the present invention. FIG. 1 is also a cross-sectional view taken along a line X-X of FIG. 2 through FIG. 5 which figures are referred to below.

Referring to FIG. 1, a mold for resin sealing of the first embodiment of the present invention includes an upper mold 1, a lower mold 2, a first intermediate mold 3 and a second intermediate mold 4. Each of the upper mold 1, the lower mold 2, the first intermediate mold 3 and the second intermediate mold 4 has a substantially same area.

The upper mold 1 is fixed to an upper mold fixing part 5 of a resin sealing apparatus. The lower mold 2 is fixed to a lower mold fixing part 6 of the resin sealing apparatus. The first intermediate mold 3 is stacked on the lower mold 2. The second intermediate mold 4 is stacked on the first intermediate mold 3. The upper mold fixing part 5 is provided on the second intermediate mold 4.

Positioning between the first intermediate mold 3 and the second intermediate mold 4 and the upper mold 1 and the lower mold 2 is made by engaging pins (not shown in FIG. 1) provided on the upper mold 1 and the lower mold 2 with hole forming parts of the first intermediate mold 3 and the second intermediate mold 4.

Concave shaped cavity forming parts 7 through 9 are formed in upper surfaces of the lower mold 2, the first intermediate mold 3, and the second intermediate mold 4.

Wiring board supporting parts 14 through 16 having depths less than the thicknesses of the cavity forming parts 7 through 9 are formed along external circumferential parts of the cavity forming parts 7 through 9 on the upper surfaces of the lower mold 2, the first intermediate mold 3, and the second intermediate mold 4 so as to be connected to the external circumferential parts of the cavity forming parts 7 through 9, respectively.

Edge part of the wiring boards 11 are provided on the wiring board supporting parts 14 through 16. Plural semiconductor elements 12 as electronic components mounted on main surfaces of the wiring boards 11 as sheet members, bonding wires 13 configured to connect electrode terminals on the wiring board 11 and outside connection terminals of the semiconductor elements 12, and others are positioned inside the cavity forming parts 7 through 9. Upper surfaces of the lower mold 2, the first intermediate mold 3, and the second intermediate mold 4 and rear surfaces of the wiring boards 11 form the same surface.

Molten resin is injected (supplied) into the cavity forming parts 7 through 9 so that the plural semiconductor elements 12 mounted on the wiring boards 11 and the bonding wires 13 are sealed by the resin.

A piercing hole is formed in parts of the lower mold 2, the first intermediate mold 3, and the second intermediate mold 4 separated from the cavity forming parts 7 through 9 and a part of the lower mold fixing part 6 corresponding to the above-mentioned parts. A hollow cylindrical part 17 is formed on the external circumferential part of the piercing hole. The hollow cylindrical part 17 can move in a vertical direction driven by a driving part not shown in FIG. 1. A pot part 18 is formed inside the hollow cylindrical part 17. Sealing resin is supplied to the pot part 18. A plunger 19 is provided in the pot part 18. The plunger part 19 can move in a vertical direction by the movement of a driving part not shown in FIG. 1. An upper part opening hole, namely an opening surface of the pot part 18 of the hollow cylindrical part 17 is connected to a cull part 20 formed on a lower surface of the upper mold 1. The sealing resin heated and made molten in the pot part 18 flows into the cull part 20 due to motion by the plunger 19.

Here, FIG. 2 in addition to FIG. 1 is referred to. FIG. 2 is a plan view of the upper mold 1 shown in FIG. 1. In FIG. 2, an area where the wiring board 11 provided on the second intermediate mold 4 provided right under the upper mold 1 and areas where plural semiconductor elements 12 are provided are indicated by two-point chain lines.

Referring to FIG. 1 and FIG. 2, the cull parts 20 formed on the lower surface of the upper mold 1 are connected to upper mold runner parts 21 formed on the lower surface of the upper mold 1. Accordingly, the sealing resin flowing into the cull part 20 due to motion by the plunger 19 flows into the upper mold runner part 21. In FIG. 2, lower surfaces of the cull parts 20 and the upper mold runner parts 21 are indicated by dotted lines.

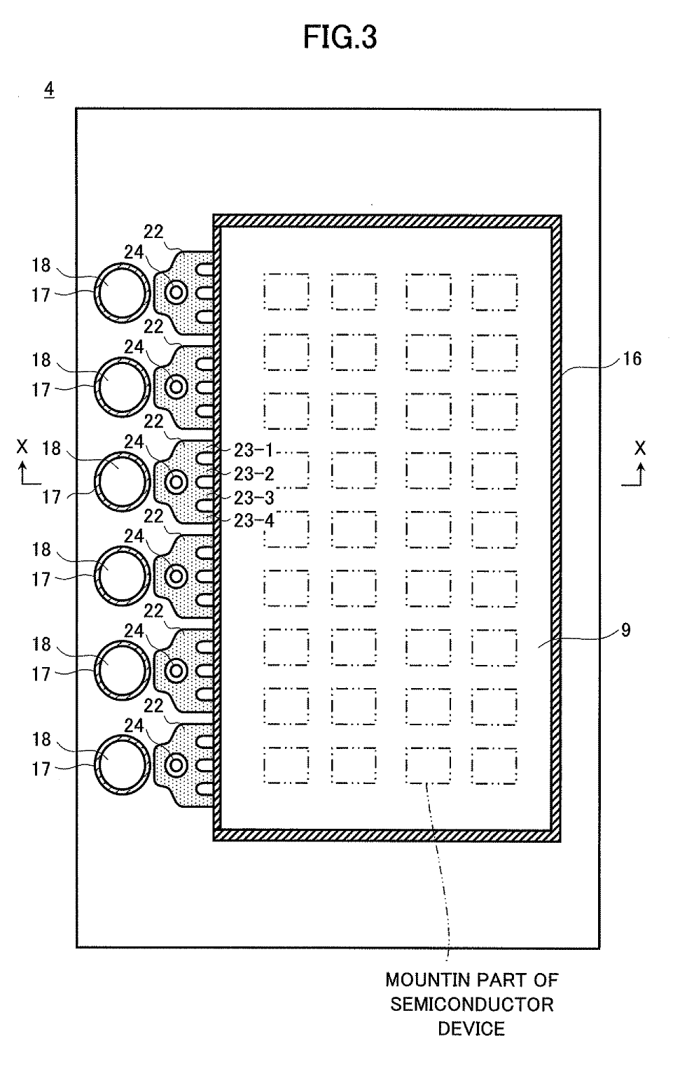

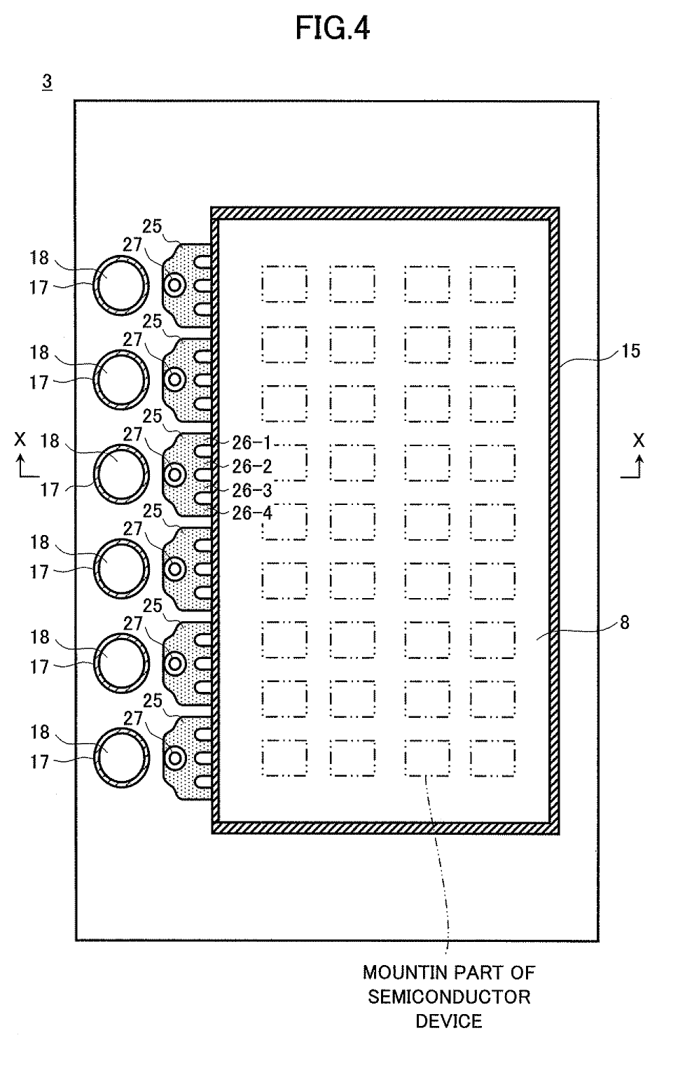

Next, FIG. 3 in addition to FIG. 1 is referred to. FIG. 3 is a plan view of the second intermediate mold 4 shown in FIG. 1. In FIG. 4, areas where plural semiconductor elements 12 are provided are indicated by two-point chain lines.

As shown in FIG. 1, the upper mold runner parts 21 of the upper mold 1 are connected to the second intermediate mold runner parts 22 formed in the second intermediate mold 4. The second intermediate mold runner parts 22 are provided between the cavity forming part 9 and the hollow cylindrical part 17 having an inside where the pot part 18 is formed.

As shown in FIG. 3, the second intermediate mold runner part 22 has a bear hand-shaped plan configuration. Gate parts 23-1 through 23-4 are provided at portions where the second intermediate mold runner part 22 and the cavity forming part 9 are connected to each other. In FIG. 3, for the convenience for seeing FIG. 3, numerical references 23-1 through 23-4 are indicated for gate parts of a certain single second intermediate mold runner part 22 and numerical references for gate parts of other second intermediate mold runner parts 22 are omitted.

In addition, as shown in FIG. 1, second intermediate mold piercing runner parts 24 are provided in the second intermediate mold runner parts 22 so as to pierce the second intermediate mold 4. The second intermediate mold piercing runner part 24 has a cross section where the second intermediate mold piercing runner part 24 tapers off toward the lower surface of the second intermediate mold 4. A bottom part of the second intermediate mold runner part 22 inclines upward to the gate part Thus, the upper mold runner part 21 connected to the pot part 18 via the cull part 20 and the cavity forming part 9 are connected to each other by the second intermediate mold runner part 22. Accordingly, the sealing resin flowing from the pot part 8 into the upper mold runner part 21 is supplied to the cavity forming part 9 via the gate part 23 of the second intermediate mold runner part 22 so as to flow in the second intermediate mold piercing runner part 24.

Next, FIG. 4 in addition to FIG. 1 is referred to. FIG. 4 is a plan view of the first intermediate mold 3 shown in FIG. 1. In FIG. 4, areas where plural semiconductor elements 12 are provided are indicated by two-point chain lines.

As shown in FIG. 1, the second intermediate mold piercing runner parts 24 of the second intermediate mold 4 are connected to the first intermediate mold runner parts 25 of the first intermediate mold 3. The first intermediate mold runner parts 22 are provided between the cavity forming part 8 and the hollow cylindrical part 17 having an inside where the pot part 18 is formed.

As shown in FIG. 4, the first intermediate mold runner part 25 has a bear hand-shaped plan configuration. Gate parts 26-1 through 26-4 are provided at portions where the first intermediate mold runner part 25 and the cavity forming part 8 are connected to each other. In FIG. 4, for the convenience for seeing FIG. 4, numerical references 26-1 through 26-4 are indicated for gate parts of a certain single first intermediate mold runner part 25 and numerical references for gate parts of other first intermediate mold runner parts 25 are omitted.

In addition, as shown in FIG. 1, first intermediate mold piercing runner parts 27 are provided in the first intermediate mold runner parts 25 so as to pierce the first intermediate mold 3. The first intermediate mold piercing runner part 27 has a cross section where the first intermediate mold piercing runner part 27 tapers off toward the lower surface of the first intermediate mold 3. A bottom part of the first intermediate mold runner part 25 inclines upward to the gate part 26.

Thus, the cull part 20, the second intermediate mold runner part 24 connected to the pot part 18 via the upper mold runner part 21, and the cavity forming part 8 are connected to each other by the first intermediate mold runner part 25. Accordingly, the sealing resin flowing to the second intermediate mold piercing runner part 24 of the second intermediate mold 4 is supplied to the cavity forming part 8 via the gate part 26 of the first intermediate mold runner part 25 so as to flow in the first intermediate mold piercing runner part 27.

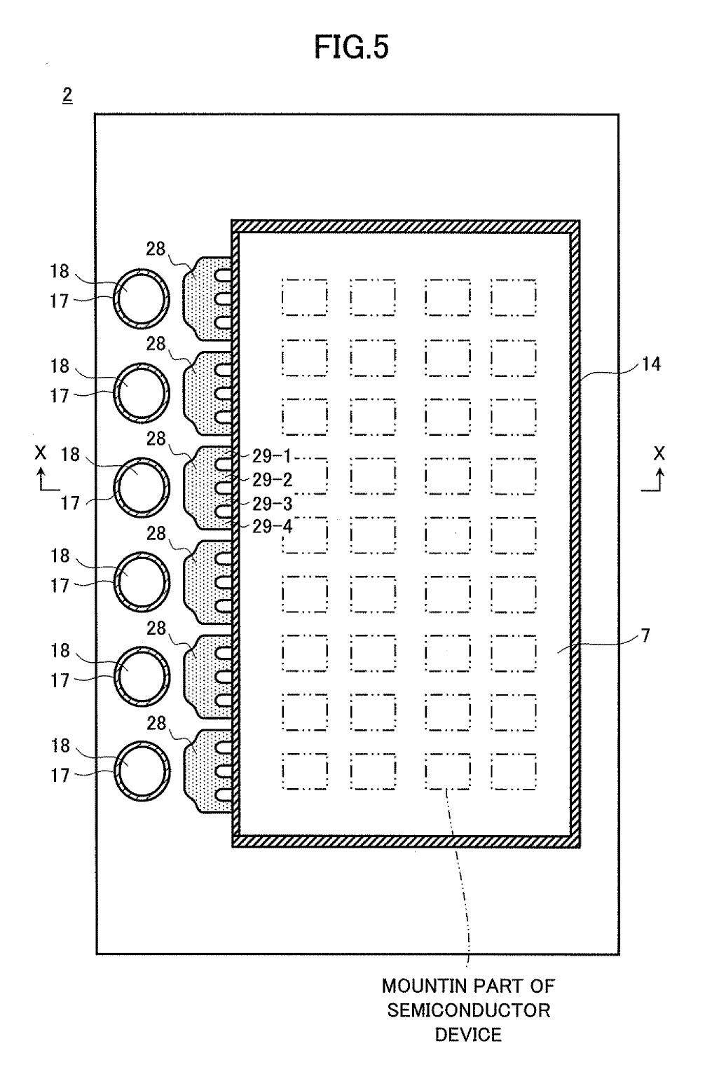

Next, FIG. 5 in addition to FIG. 1 is referred to. FIG. 5 is a plan view of the lower mold 2 shown in FIG. 1. In FIG. 5, areas where plural semiconductor elements 12 are provided are indicated by two-point chain lines.

As shown in FIG. 1, the first intermediate mold piercing runner parts 27 of the first intermediate mold 3 are connected to the lower mold runner parts 28 formed in the lower mold 2. The lower mold runner parts 28 are provided between the cavity forming part 8 and the hollow cylindrical part 17 having an inside where the pot part 18 is formed.

As shown in FIG. 5, the lower mold runner part 28 has a bear hand-shaped plan configuration. Gate parts 29-1 through 29-4 are provided at portions where the lower mold runner part 28 and the cavity forming part 7 are connected to each other. In FIG. 5, for the convenience for seeing FIG. 5, numerical references 29-1 through 29-4 are indicated for gate parts of a certain single lower mold runner part 28 and numerical references for gate parts of other lower mold runner parts 28 are omitted. In addition, as shown in FIG. 1, a bottom part of the lower mold runner part 28 inclines upward to the gate part 29.

Thus, the first intermediate mold piercing runner part 27 connecting to the pot part 18 via the cull part 20, the upper mold runner part 21, and the second intermediate mold runner part 24 and the cavity forming part 7 are connected to each other by the lower mold runner part 28. Accordingly, the sealing resin to the first intermediate mold runner part 27 of the first intermediate mold 3 is supplied to the cavity forming part 7 via the gate part 29 of the lower mold runner part 28.

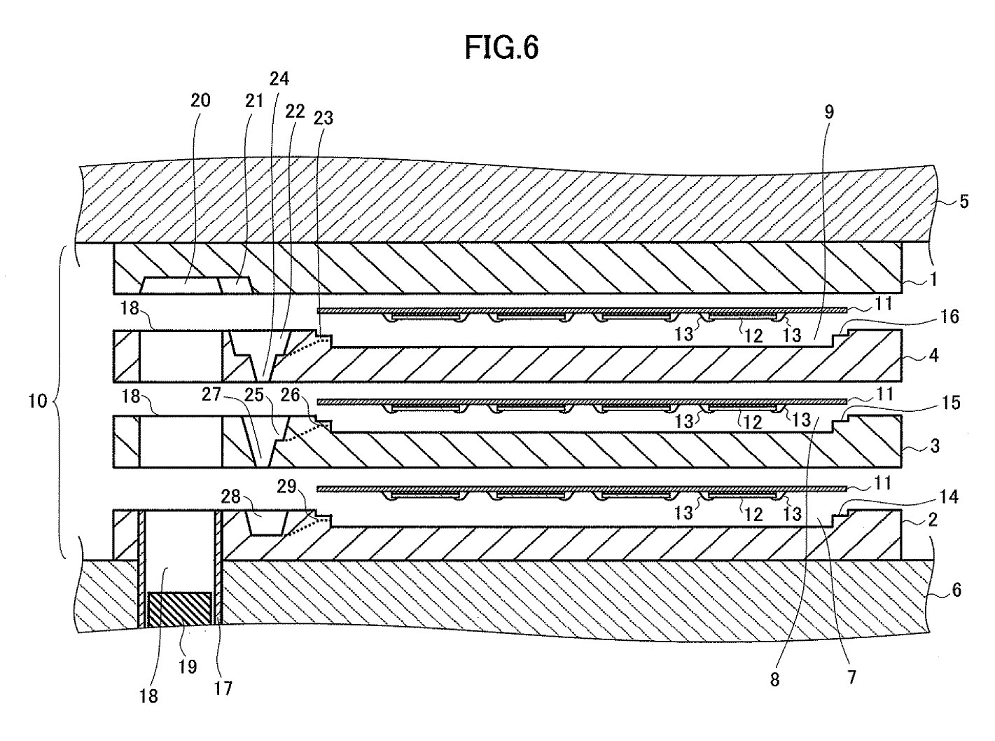

Next, a resin sealing method using the mold 10 for resin sealing is discussed with reference to FIG. 6 through FIG. 12. Here, FIG. 6 through FIG. 12 are first through seventh views for explaining the resin sealing method using the mold 10 for resin sealing shown in FIG. 1.

Referring to FIG. 6, first, the wiring boards 11 having the main surfaces where plural semiconductor elements 12 are mounted are set on the lower mold 2 fixed to the lower mold fixing part 6 of the resin sealing apparatus, the first intermediate mold 3, and the second intermediate mold 4.

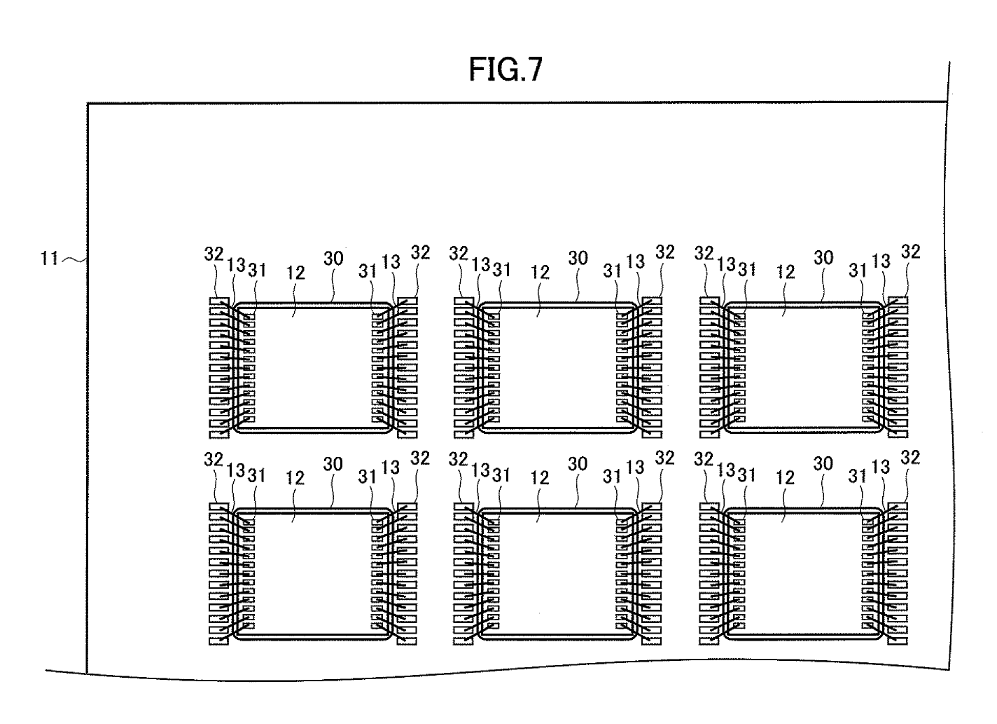

FIG. 7 is a partial plan view of the wiring board 11. As shown in FIG. 7, plural semiconductor elements 12 are mounted and fixed on the wiring board 11 via adhesives 30. The adhesives 30 such as die bonding film are adhered on rear surfaces of the semiconductor elements 12 where an electronic circuit element, an electronic circuit, and others are not formed. The outside connection terminals (electrode pads) 31 of the semiconductor element 12 and electrode terminals 32 on the wiring board 11 are connected to each other by the bonding wires 13.

Referring back to FIG. 6, the wiring boards 11 are set in the concave shaped cavity forming parts 7 through 9 formed on the upper surfaces of the lower mold 2, the first intermediate mold 3, and the second intermediate mold 4.

More specifically, the wiring boards 11 are set so that edge parts of the wiring boards 11 are positioned on the wiring board supporting parts 14 through 16 having depths less than the thicknesses of the cavity forming parts 7 through 9. At this time, the upper surfaces of the cavity forming parts 7 through 9 have the same plan surfaces as the rear surfaces of the wiring boards 11.

In addition, the first intermediate mold 3 and the second intermediate mold 4 where the wiring boards 11 are set are provided between the upper mold 1 fixed to the upper mold fixing part 5 of the resin sealing apparatus and the lower mold 2 fixed to the lower mold fixing part 6 of the resin sealing apparatus.

More specifically, the first intermediate mold 3 is stacked on the lower mold 2 and the second intermediate mold 4 is stacked on the first intermediate mold 3. Positioning of the first intermediate mold 3 and the second intermediate mold 4 against the upper mold 1 and the lower mold 2 are made by engaging pins (not illustrated) provided on the upper mold 1 and the lower mold 2 and hole forming parts (not illustrated) formed in the first intermediate mold 3 and the second intermediate mold 4.

In this stage, the upper mold 1 and the lower mold 2 are heated by a heating mechanism (not illustrated), such as a pressurizing head and a stage, provided at the upper mold fixing part 5 and the lower mold fixing part 6.

Furthermore, in this stage, an upper surface of the hollow cylindrical part 17 which can move in the lower mold 2, the first intermediate mold 3, and the second intermediate mold 4 in the vertical direction by the driving part (not illustrated) is positioned in the same surface as the upper surface of the lower mold 2.

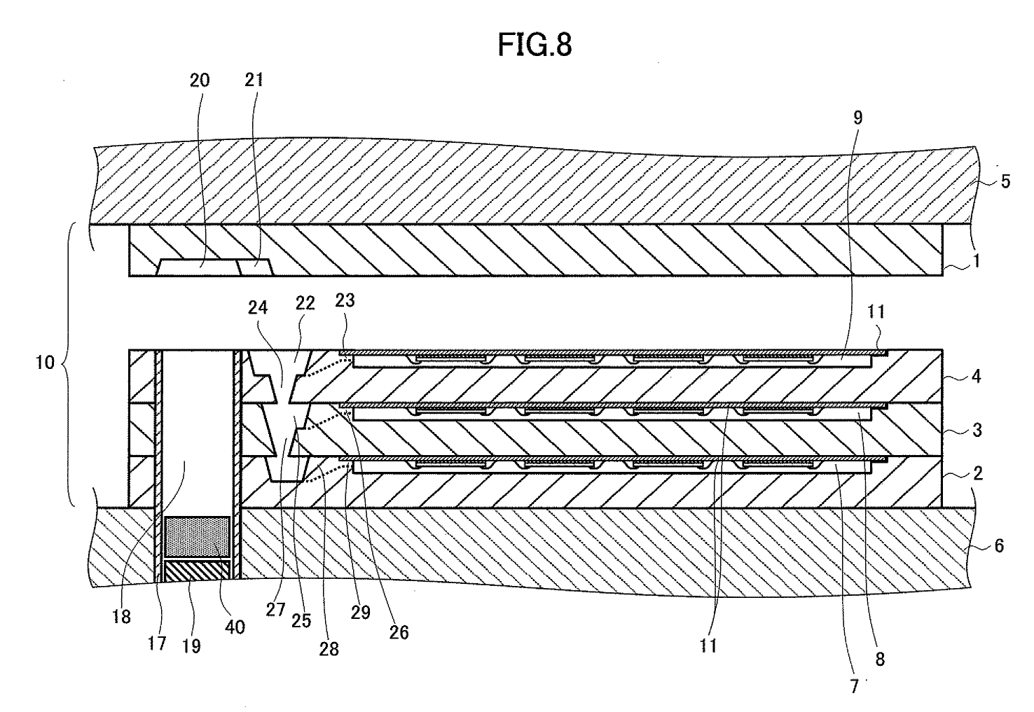

Next, as shown in FIG. 8, in a state where the first intermediate mold 3 is stacked on the lower mold 2 and the second intermediate mold 4 is stacked on the first intermediate mold 3, the hollow cylindrical part 17 rises in a vertical direction until the upper surface of the hollow cylindrical part 17 is situated in the same position of the upper surface of the second intermediate mold 4. As a result of this, the pot parts 18 of the lower mold 2, the first intermediate mold 3, and the second intermediate mold 4 are in communication with each other.

In this state, a solid state sealing resin tablet 40 is lowered from the opening part of the hollow cylindrical part 17 and is provided on the upper surface of the plunger 19 positioned in the lower mold fixing part 6.

There is no limitation in materials forming the solid state sealing resin tablet 40. For example, epoxy resin, inorganic filler, curing agent, mold releasing agent, and others may be used as the material forming the solid state sealing resin tablet 40. These examples may be used in second through fifth embodiments of the present invention discussed below as the material forming the solid state sealing resin tablet 40.

The solid state sealing resin tablet 40 may be provided on the upper surface of the plunger 19 positioned in pot part 18 of the lower mold fixing part 6 where the lower mold 2 is fixed before the first intermediate mold 3 is stacked on the lower mold 2 and the second intermediate mold 4 is stacked on the first intermediate mold 3.

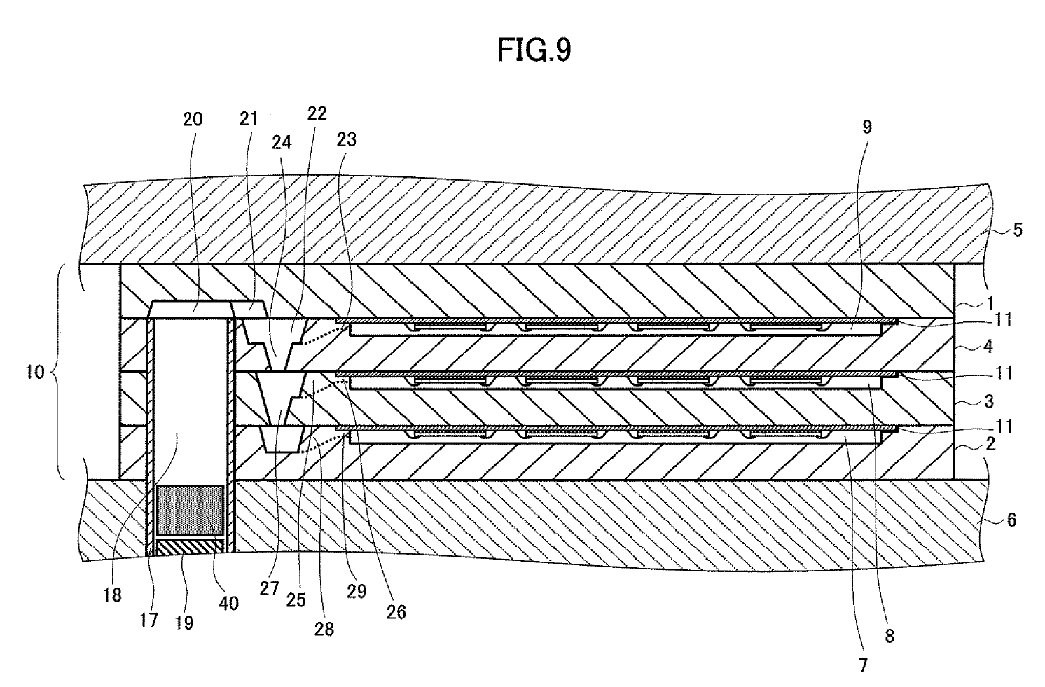

After that, as shown in FIG. 9, the upper mold 1 fixed to the upper mold fixing part 5 is made to contact the second intermediate mold 4 for mold closing and then mold clamping is performed with a designated pressing pressure.

At the same time, the first intermediate mold 3 and the second intermediate mold 4 are heated by a heating mechanism (not illustrated). As a result of this, the solid state sealing resin tablet 40 provided on the upper surface of the plunger 19 is melted. By heating the first intermediate mold 3 and the second intermediate mold 4 at a designated temperature, it is possible to make flowing properties of the molten sealing resin 40 when the resin 40 flows in the cavity forming parts 7 through 9 stable. In addition, it is possible to reduce a cycle time when sealing operations are continuously performed.

Depending on materials of the sealing resin 40, for example, the first intermediate mold 3 and the second intermediate mold 4 may be heated at approximately 150 through 190° C. so that the temperature of the sealing resin 40 becomes approximately 60 through 95° C. In addition, depending on the design of the mold 10 for resin sealing, a size of the resin sealing apparatus, or the like, the clamping pressure may be equal to or greater than approximately 29 kN and equal to or less than approximately 490 kN. These conditions can be applied to the second through fifth embodiments of the present invention.

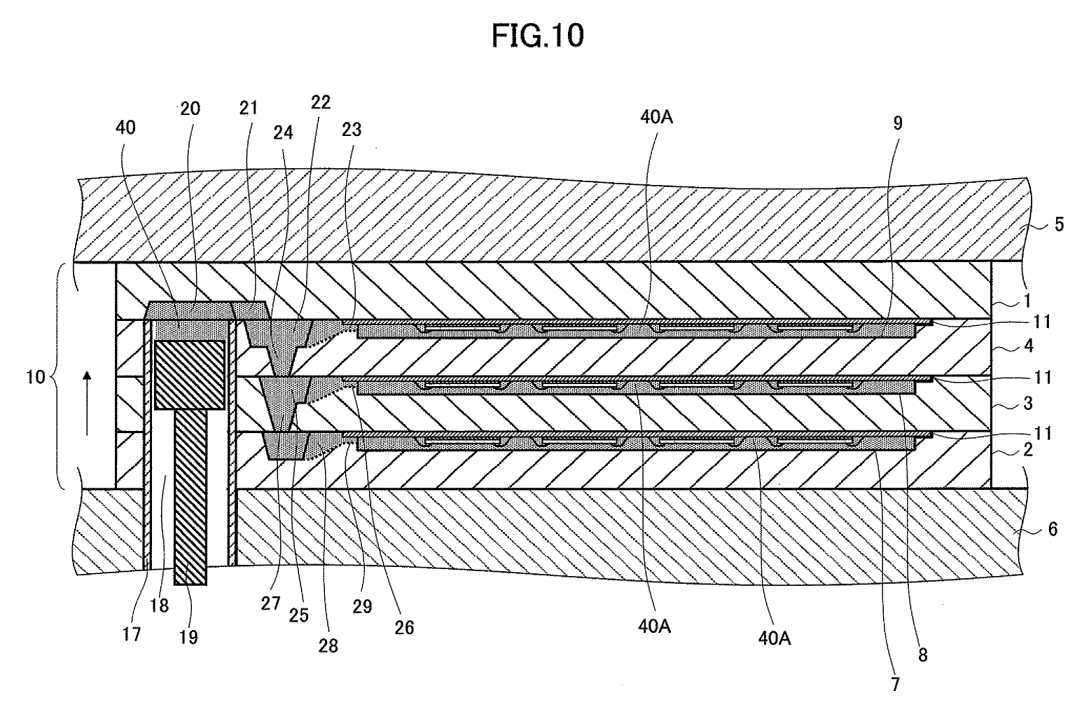

Next, as shown in FIG. 10, the plunger having the upper surface where the molten resin 40 is provided rises in the vertical direction due to the driving part not shown in FIG. 10.

As a result of this, the molten resin 40 flows from the upper part opening hole of the hollow cylindrical part 17, namely an opening surface of the pot part 18, to the second intermediate mold runner part 22 via the cull part 20 formed on the lower surface of the upper mold 1 and the upper mold runner part 21 communicating with the cull part 20.

In addition, the molten resin 40 is supplied to the cavity forming part 2 of the second intermediate mold 4 via the gate part 23 of the second intermediate mold runner part 22 and flows to the second intermediate mold piercing runner part 24. Furthermore, the molten resin 40 is supplied to the cavity forming part 8 of the first intermediate mold 3 via the gate part 26 of the first intermediate mold runner part 25 communicating with the second intermediate mold piercing runner part 24 and flows to the first intermediate mold piercing runner part 27. In addition, the molten resin 40 is supplied to the cavity forming part 7 of the lower mold 2 via the gate part 29 of the lower mold runner part 28 communicating with the first intermediate mold piercing runner part 27.

Depending on materials of the sealing resin 40, design of the mold for resin sealing, a structure of the molded product, or the like, for example, injection pressure applied to the cavity forming parts 7 through 9 may be approximately 5 through 20 MPa. In addition, a molding time may be equal to or greater than approximately 25 seconds in a case where the molten resin 40 is a fast cure type resin. A molding time may be equal to or greater than approximately 100 seconds in a case where the molten resin 40 is a normal resin. These conditions can be applied to the second through fifth embodiments of the present invention.

Thus, the molten resin 40 is supplied to the cavity forming part 7 of the lower mold 2, the cavity forming part 8 of the first intermediate mold 3, and the cavity forming part 9 of the second intermediate mold 4, so that plural semiconductor elements 12 mounted on the wiring board 11 and the bonding wires 13 situated inside the cavity forming parts 7 through 9 are dipped in the sealing resin 40A inside the cavity forming parts 7 through 9.

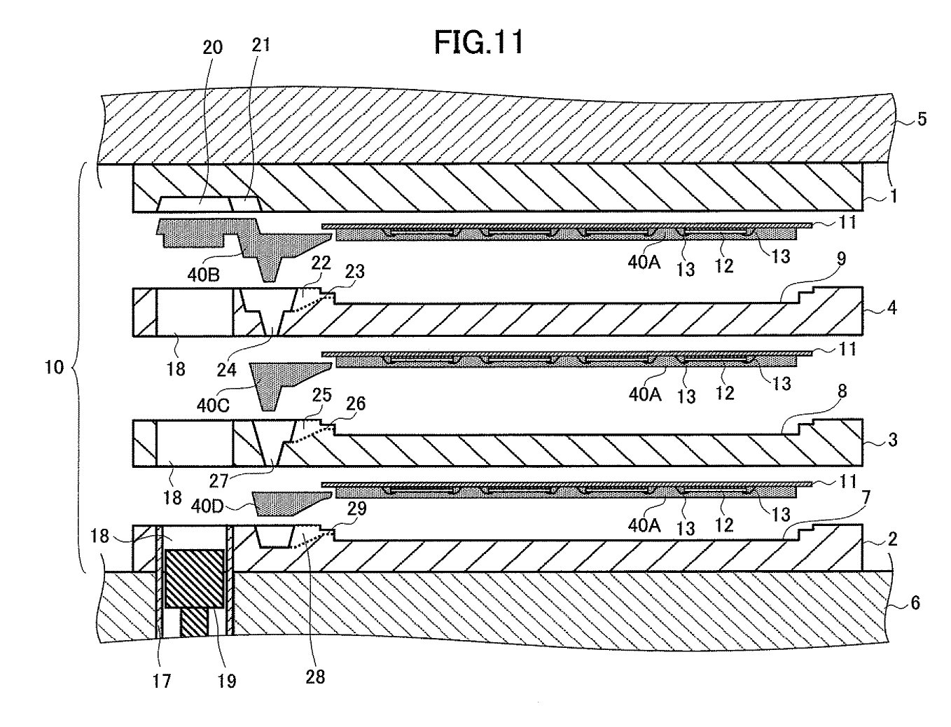

After sealing with resin is completed, as shown in FIG. 11, mold opening is performed so that the wiring board 11 having the main surface where plural semiconductor elements 12 and the bonding wires 13 are sealed is taken out from the mold 10 for resin sealing.

At this time, not only the sealing resin 40A in the cavity forming parts 7 through 9 but also the sealing resin 40B filling in the cull part 20, the upper mold runner 21, the second intermediate mold runner part 22, the gate part 23 and the second intermediate mold piercing runner part 24, the sealing resin 40C filling in the first intermediate mold runner part 27, the first intermediate mold runner part 25, and the gate part 26, and the sealing resin 40D filling in the lower mold runner part 28 and the gate part 29 are solidified.

In this step, the plunger 19 and the hollow cylindrical part 17 whose surface is situated in the same position as the upper surface of the second intermediate mold 4 is lowered in a vertical direction by a driving part (not illustrated).

Next, the mold is opened so that the upper mold 1, the first intermediate mold 3, the second intermediate mold 4, and the lower mold 2 are released. More specifically, the first intermediate mold 3 and the second intermediate mold 4 are separated from the mold 10 for resin sealing.

When the first intermediate mold 3 and the second intermediate mold 4 are separated from the mold 10 for resin sealing, a part of the sealing resin 40B contacting the upper mold 1, a part where the sealing resin 40B and the sealing resin 40C are made to contact each other, and a part where the sealing resin 40C and the sealing resin 40D are made to contact each other are cut.

The second intermediate mold piercing runner part 24 has a cross section where the second intermediate mold piercing runner part 24 tapers off toward the lower surface of the second intermediate mold 4. The first intermediate mold piercing runner part 27 has a cross section where the first intermediate mold piercing runner part 27 tapers off toward the lower surface of the first intermediate mold 3. Accordingly, a part where the sealing resin 40B and the sealing resin 40C are made to contact to each other, and a part where the sealing resin 40C and the sealing resin 40D are made to contact each other can be easily cut.

Next, the wiring boards 11 are taken from the lower mold 2, the first intermediate mold 3, and the second intermediate mold 4. While there is no limitation in a method for taking out the wiring boards 11, if necessary, the wiring boards 11 may be taken out by an eject mechanism using eject pins (not illustrated) provided in the upper mold 1, the first intermediate mold 3, the second intermediate mold 4, and the lower mold 2. Alternatively, a release film (not illustrated) made of, for example, fluoride resin may be provided on bottom parts of the cavity forming parts 7 through 9 in advance before the sealing resin 40 is supplied and mold releasing may be performed by using the release film.

When the wiring boards 11 are taken out from the lower mold 2, the first intermediate mold 3, and the second intermediate mold 4, the above-discussed sealing resin 40B, the sealing resin 40C and the sealing resin 40D are separated from the sealing resin 40A in the cavity forming parts 7 through 9. Alternatively, after the wiring boards 11 are taken out from the lower mold 2, the first intermediate mold 3, and the second intermediate mold 4, the above-discussed sealing resin 40B, the sealing resin 40C and the sealing resin 40D may be separated from the sealing resin 40A. The bottom part of the second intermediate mold runner part 22, the bottom part of the first intermediate mold runner part 25, and the bottom part of the lower mold runner part 28 incline upward to the gate parts 23, 26, and 29, respectively. Accordingly, parts where the sealing resin 40B, the sealing resin 40C and the sealing resin 40D contact the sealing resin 40A are easily cut.

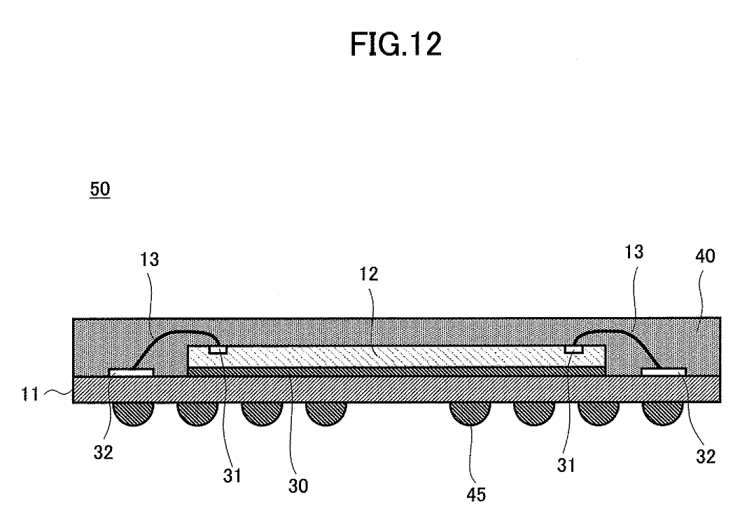

After the plural semiconductor elements 12 and the bonding wires 13 mounted and fixed on the main surface of the wiring board 11 are sealed by the sealing resin 40A in a lump, the wiring board 11 is heated by a constant temperature oven so that the sealing resin 40A is completely cured. While depending on materials forming the sealing resin 40, the heating temperature and time may be, for example, 175° C. and four hours. After that, plural outside connection terminals 45 made of solder balls are provided on another main surface of the wiring board 11. The wiring board 11 is cut by dicing using a dicing saw for every pieces having a single semiconductor element 12 and the bonding wires 13 sealed by the sealing resin 40A. Thus, a semiconductor device 50 (see FIG. 12) is formed.

Thus, in the first embodiment of the present invention, plural wiring boards 11 are provided in the cavity forming parts 8 and 9 of the intermediate molds 3 and 4 sandwiched by the upper mold 1 and the lower mold 2 and in the cavity forming part 7 of the lower mold 2. The cavity forming parts 7 through 9 of the lower mold 2 and the intermediate molds 3 and 4 are formed in positions corresponding to portions of the wiring boards 11 where the semiconductor elements 12 and the bonding wires 13 are situated.

The lower mold runner part 28, the first intermediate mold runner part 25, and the second intermediate mold runner part 22 which are resin paths connecting to the cavity forming parts 7 through 9 are formed in the lower mold 2 and the intermediate molds 3 and 4 having the cavity forming parts 7 through 9. The resin supplied from the pot part 18 which is a single resin supplying source via the cull part 20 and the upper mold runner part 21 fills in the cavity forming parts 7 through 9.

Accordingly, it is possible to seal the wiring boards stacked via the intermediate molds 3 and 4 at the same time and in a lump. Hence, it is possible to improve manufacturing efficiency in the resin sealing step without making sizes of the upper mold 1, the lower mold 2 and the wiring boards 11 large, namely without increasing the manufacturing costs.

In addition, the first intermediate mold piercing runner part 27 and the second intermediate mold piercing runner part 24 are formed in the first intermediate mold runner part 25 and the second intermediate mold runner part 22 which are the resin paths connecting to the cavity forming parts 8 and 9, as the resin paths piercing the intermediate molds 3 and 4, respectively.

The lower mold runner part 28, the first intermediate mold runner part 25, and the second intermediate runner mold 22 which are resin paths configured to supply the wiring boards 11 stacked in the mold 10 for resin sealing are in communication with each other by the piercing resin paths 24 and 27. Accordingly, it is possible to supply the resin from the pot part 18 which is a single resin supplying source to the lower mold 2 and the intermediate molds 3 and 4. Hence, it is possible to simplify a structure of the resin sealing apparatus so that manufacturing cost of the resin sealing apparatus can be made low.

In addition, the resin is supplied from end parts of the cavity forming parts 7 through 9 to the cavity forming parts 7 through 9 in a horizontal direction via the gate parts 23, 26, and 29 of the lower mold runner part 28, the first intermediate mold runner part 25, and the second intermediate mold runner part 22. Accordingly, in a case where the resin is supplied to the cavity forming parts 7 through 9 in vertical directions, the mold product may be damaged when the molds are released. However, in the first embodiment of the present invention, since the resin is supplied to the cavity forming parts 7 through 9 horizontally, such a problem may be avoided.

In addition, as discussed above, mold closing is done by contacting the upper mold to the second intermediate mold 4, and then the first intermediate mold 3 and the second intermediate mold 4 are heated at a designated temperature by a heating mechanism (not illustrated) so that the entire mold 10 for resin sealing has an even temperature. Because of this, it is possible to make the flow properties at the time when the molten resin 40 flows in the cavity forming parts 7 through 9 stable. In addition, it is possible to reduce a cycle time when the entire sealing operations are continuously performed.

### Second Embodiment

In the first embodiment of the present invention, the pot part 18 which is a single resin supplying source is provided in the lower mold 2 and the intermediate molds 3 and 4 where the cavity forming parts 7 through 9 are formed. The resin is supplied from the pot part 18 to the cavity forming parts 7 through 9 via the lower mold runner part 28, the first intermediate mold runner part 25, and the second intermediate mold runner part 22 which are resin paths communicating with the cavity forming parts 7 through 9.

However, the present invention is not limited to this example. The present invention can be applied to an example where the molten resin is independently supplied to the cavity forming parts of stacked molds.

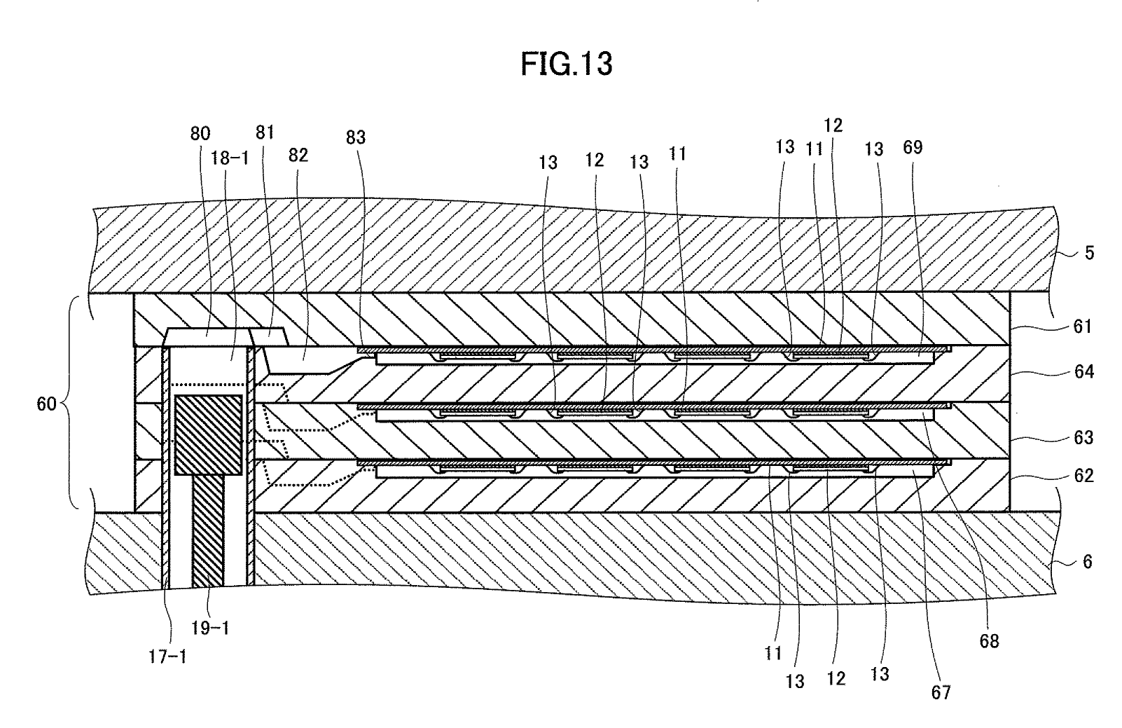

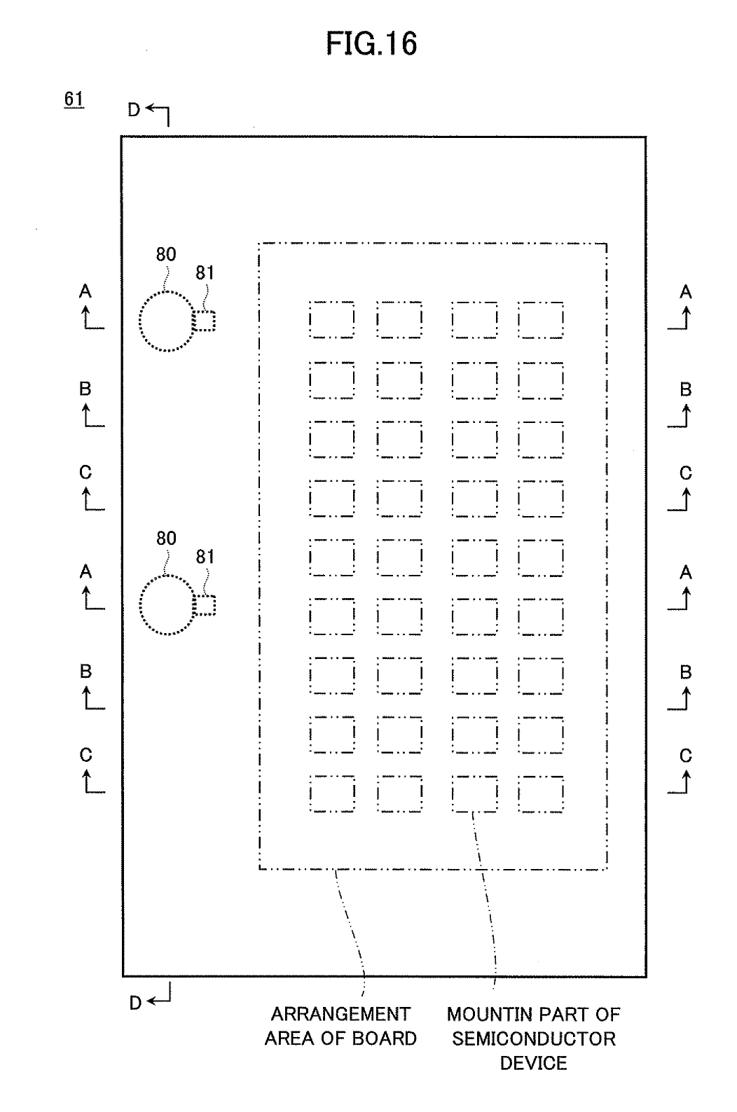

FIG. 13 is a first schematic cross-sectional view of a mold for resin sealing provided in a resin sealing apparatus used for a resin sealing method of an electronic component of a second embodiment of the present invention. FIG. 13 is a cross-sectional view taken along line A-A of FIG. 16 through FIG. 19.

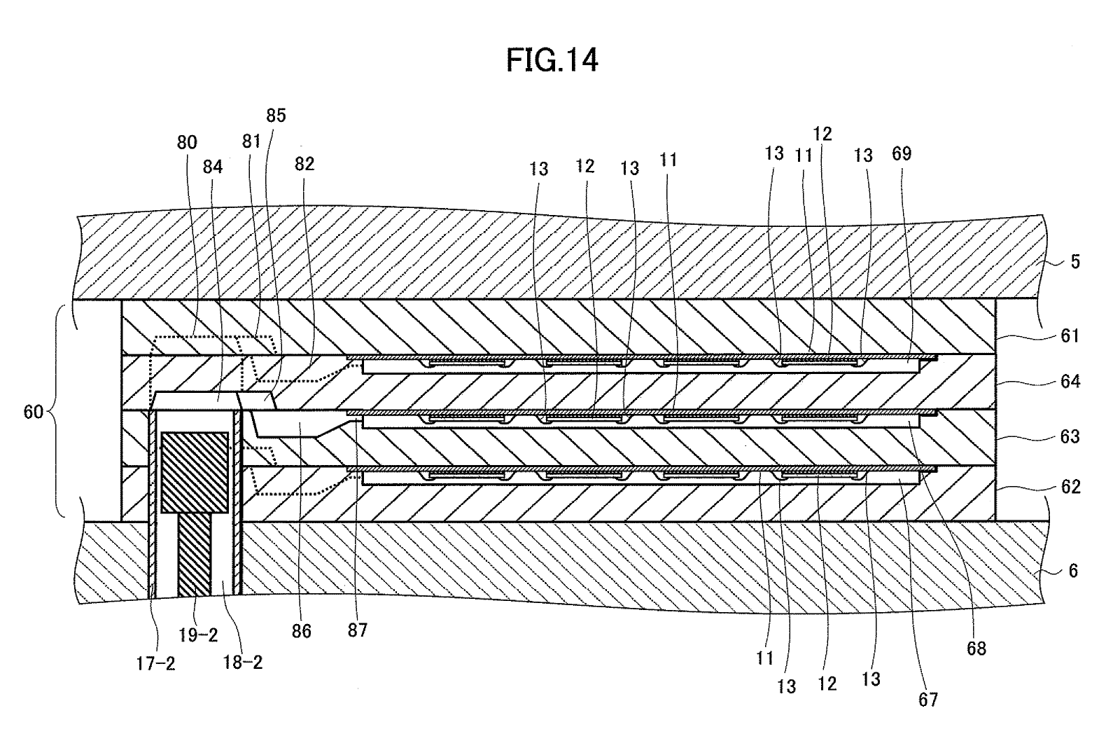

FIG. 14 is a second schematic cross-sectional view of the mold for resin sealing provided in the resin sealing apparatus used for the resin sealing method of the electronic component of the second embodiment of the present invention. FIG. 14 is a cross-sectional view taken along line B-B of FIG. 16 through FIG. 19.

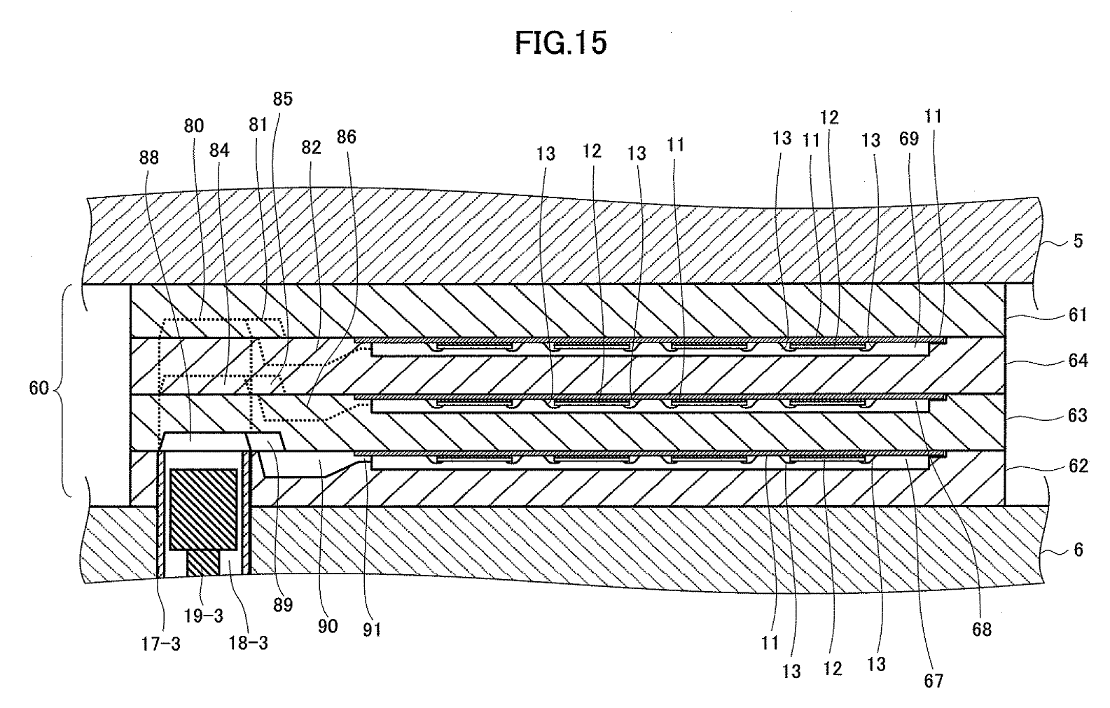

FIG. 15 is a third schematic cross-sectional view of a mold for resin sealing provided in the resin sealing apparatus used for the resin sealing method of an electronic component of the second embodiment of the present invention. FIG. 15 is a cross-sectional view taken along line C-C of FIG. 16 through FIG. 19.

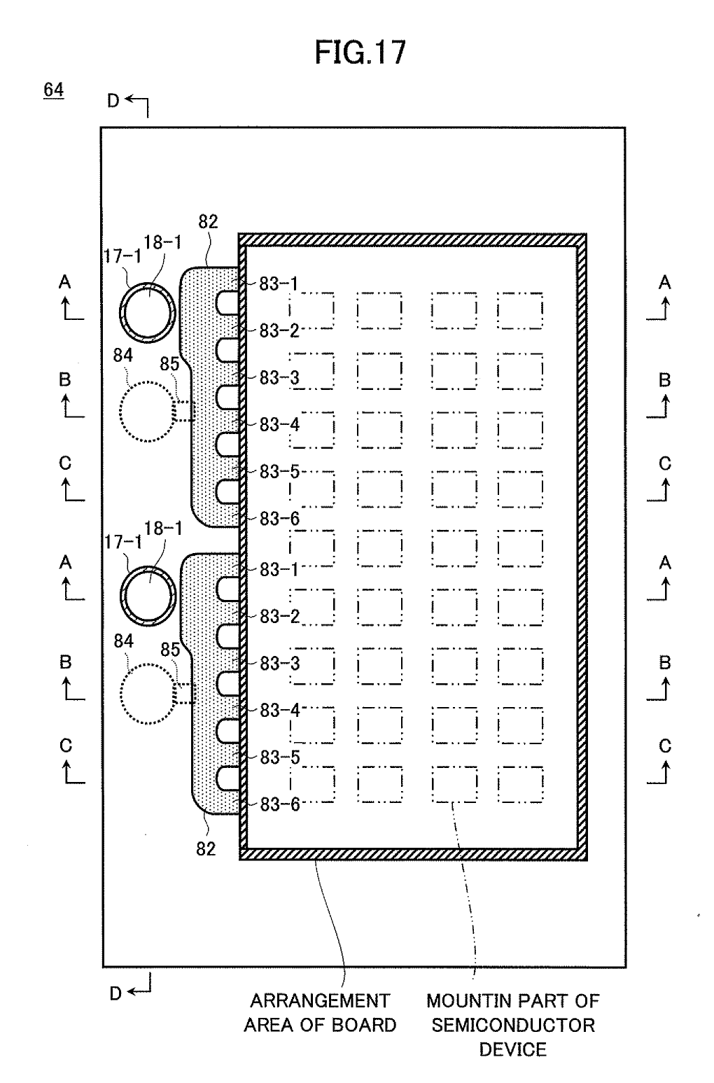

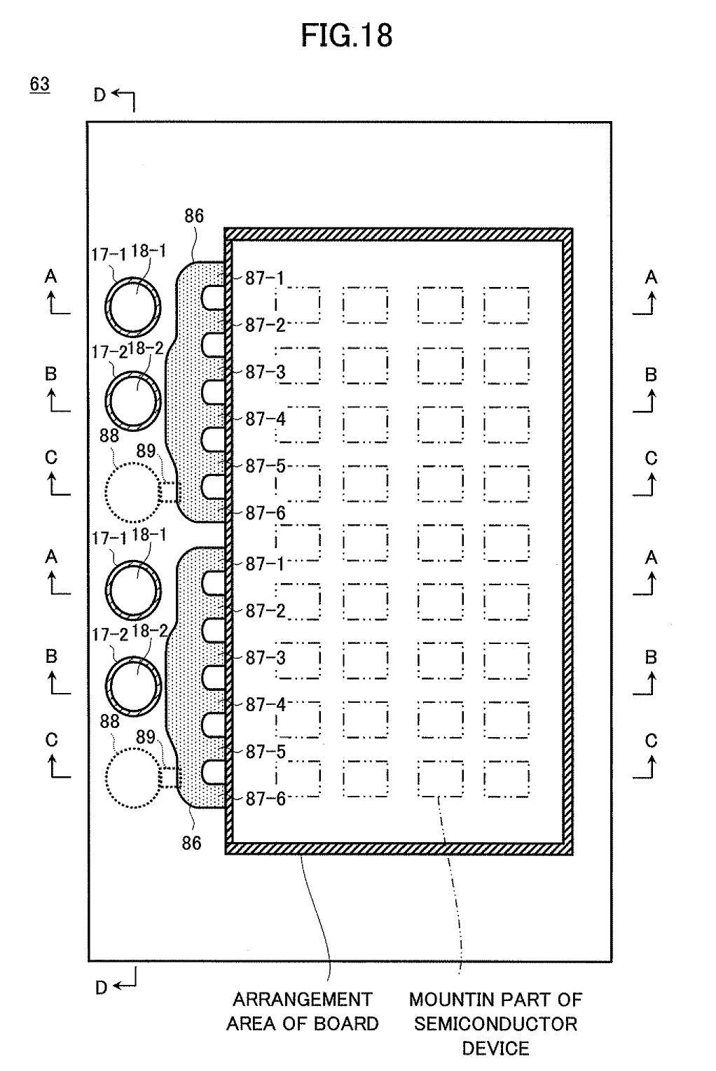

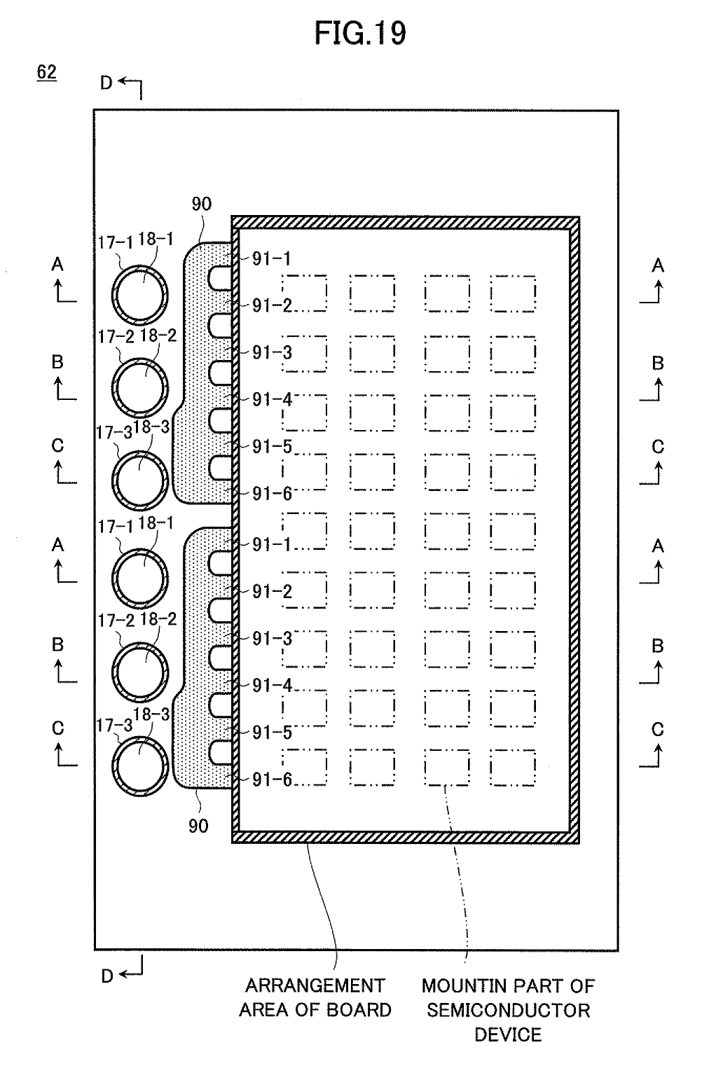

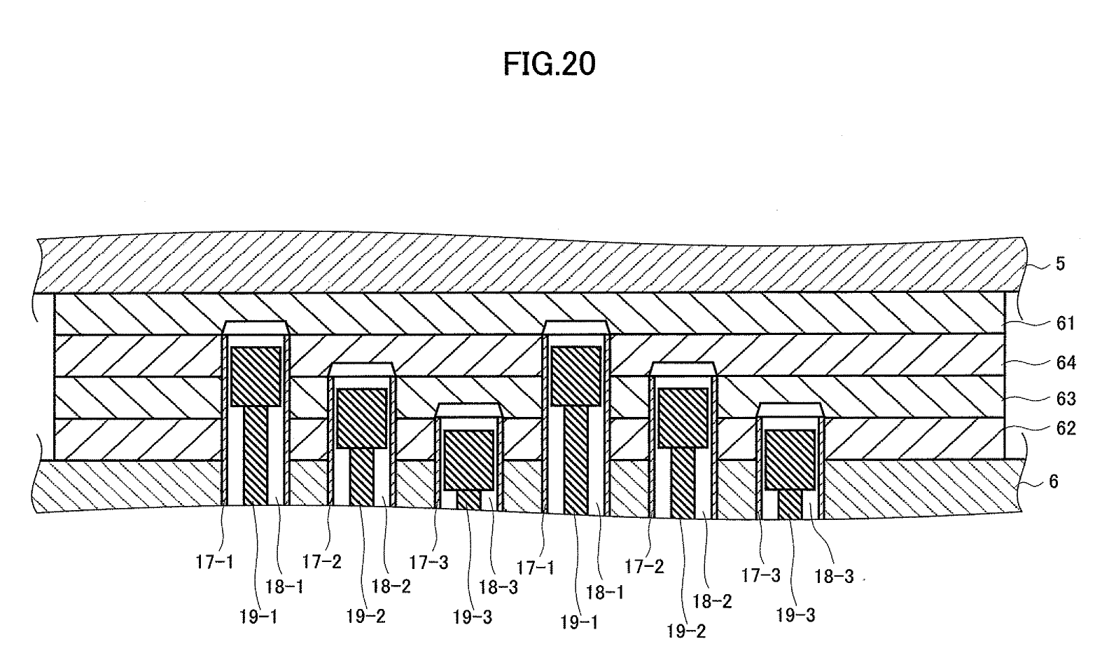

Here, FIG. 16 is a plan view of an upper mold 61 shown in FIG. 13 through FIG. 15. FIG. 17 is a plan view of a second intermediate mold 64 shown in FIG. 13 through FIG. 15. FIG. 18 is a plan view of a first intermediate mold 63 shown in FIG. 13 through FIG. 15. FIG. 19 is a plan view of a lower mold 62 shown in FIG. 13 through FIG. 15. FIG. 20 is a cross-sectional view taken along a line D-D of FIG. 16 through FIG. 19.

In FIG. 13 through FIG. 20, parts that are the same as the parts shown in FIG. 1 through FIG. 12 are given the same reference numerals, and explanation thereof is omitted. Furthermore, in FIG. 16 through FIG. 19, for the convenience of explanation, illustration of the plunger 19 is omitted.

Referring to FIG. 13 through FIG. 15, a mold 60 for resin sealing of the second embodiment of the present invention includes an upper mold 61, a lower mold 62, a first intermediate mold 63 and a second intermediate mold 64. Each of the upper mold 61, the lower mold 62, the first intermediate mold 63 and the second intermediate mold 64 has a substantially same area.

The upper mold 61 is fixed to an upper mold fixing part 5 of a resin sealing apparatus. The lower mold 62 is fixed to a lower mold fixing part 6 of the resin sealing apparatus. The first intermediate mold 63 is stacked on the lower mold 62. The second intermediate mold 64 is stacked on the first intermediate mold 63. The second intermediate mold 64 is provided on the upper mold 61.

Positioning between the first intermediate mold 63 and the second intermediate mold 64 and the upper mold 61 and the lower mold 62 is made by engaging pins (not shown) provided on the upper mold 61 and the lower mold 62 with hole forming parts of the first intermediate mold 63 and the second intermediate mold 64.

Concave shaped cavity forming parts 67 through 69 are formed in upper surfaces of the lower mold 62, the first intermediate mold 63, and the second intermediate mold 64. The wiring boards 11 are provided in the cavity forming parts 67 through 69 so that the plural semiconductor elements 12 mounted on the main surfaces of the wiring boards 11 and the bonding wires 13 connecting outside connection terminals of the semiconductor elements 12 and electrode terminals on the wiring boards are situated inside the cavity forming parts 67 through 69 and the upper surfaces of the lower mold 62, the first intermediate mold 63 and the second intermediate mold 64 are situated in the same position as the rear surface of the wiring boards 11.

Molten resin is injected (supplied) into the cavity forming part 67 through 69 so that plural semiconductor elements 12 mounted on the wiring boards 11 and the bonding wires 13 are sealed by the resin.

Here, FIG. 16 through FIG. 19 in addition to FIG. 13 through FIG. 15 are referred to.

In a position indicated by a line A-A in FIG. 16 through FIG. 19, a piercing hole is formed in parts of the lower mold 62, the first intermediate mold 63, and the second intermediate mold 64 and the lower mold fixing part 6. A first hollow cylindrical part 17-1 is formed on the external circumferential part of the piercing hole. The first hollow cylindrical part 17-1 can move in a vertical direction by a driving part not shown. A first pot part 18-1 is formed inside the first hollow cylindrical part 17-1. A first plunger 19-1 is provided in the first pot part 18-1. The first plunger part 19-1 can move in a vertical direction by a driving part not shown. An upper part opening hole, namely an opening surface of the first pot part 18-1 of the first hollow cylindrical part 17-1 is connected to an upper cull part 80 formed on a lower surface of the upper mold 61. The sealing resin heated and made molten in the first pot part 18-1 flows into the upper mold cull part 80 by movement of the first plunger 19-1.

Referring to FIG. 16, the upper mold cull parts 80 formed on the lower surface of the upper mold 61 are connected to upper mold runner parts 81 formed on the lower surface of the upper mold 61. Accordingly, the sealing resin flowing into the upper mold cull part 80 by the first plunger 19-1 flows into the upper mold runner part 81. In FIG. 16, lower surfaces of the upper mold cull part 80 and the upper mold runner parts 81 are indicated by dotted lines. In addition, areas of the wiring boards 11 where plural semiconductor elements 12 are provided and areas of the second intermediate mold 64 situated right under the upper mold 61 where the wiring boards 11 are provided are indicated by two-point chain lines.

As shown in FIG. 13, the upper mold runner parts 81 of the upper mold 61 are connected to the second intermediate mold runner parts 82 formed in the second intermediate mold 64.

As shown in FIG. 17, the second intermediate mold runner part 82 has a bear hand-shaped plan configuration. Gate parts 83-1 through 83-4 are provided at portions where the second intermediate mold runner part 82 and the cavity forming part 69 are connected to each other.

Thus, the upper mold runner part 81 connecting to the first pot part 18-1 via the upper mold cull part 80 and the cavity forming part 69 are connected to each other by the second intermediate mold runner part 82. Accordingly, the sealing resin flowing from the first pot part 18-1 into the upper mold runner part 81 is supplied to the cavity forming part 69 via the gate part 23 of the second intermediate mold runner part 82.

In the meantime, as shown in FIG. 14, in a position indicated by a line B-B in FIG. 16 through FIG. 19, a piercing hole is formed in parts of the lower mold 62, the first intermediate mold 63, and the second intermediate mold 64 and the lower mold fixing part 6. A second hollow cylindrical part 17-2 is formed on the external circumferential part of the piercing hole. The second hollow cylindrical part 17-2 can move in a vertical direction by a driving part not shown. A second pot part 18-2 is formed inside the second hollow cylindrical part 17-2. A second plunger 19-2 is provided in the second pot part 18-2. The second plunger part 19-2 can move in a vertical direction by a driving part not shown. An upper part opening hole, namely an opening surface of the second pot part 18-2 of the second hollow cylindrical part 17-2 is connected to a second intermediate mold cull part 84 formed on a lower surface of the second intermediate mold 64. The sealing resin heated and made molten in the second pot part 18-2 flows into the second intermediate mold cull part 84 by the second plunger 19-2.

The second intermediate mold cull part 84 is connected to the second intermediate mold runner part 85 formed on the lower surface of the second intermediate mold 64. Accordingly, the sealing resin flowing into the second intermediate mold cull part 84 by the second plunger 19-2 flows into the second intermediate mold runner part 85. In FIG. 17, lower surfaces of the second intermediate mold cull part 84 and the second intermediate mold runner parts 85 are indicated by dotted lines. In addition, areas of the plural semiconductor elements 12 mounted on the wiring boards in the first intermediate mold 63 provided right under the second intermediate mold 64 are indicated by two-point chain lines.

As shown in FIG. 14, the second intermediate mold runner parts 85 of the second intermediate mold 64 are connected to the first intermediate mold runner parts 86 formed in the first intermediate mold 63.

As shown in FIG. 18, the first intermediate mold runner part 86 has a bear hand-shaped plan configuration. Gate parts 87-1 through 87-6 are provided at portions where the first intermediate mold runner part 86 and the cavity forming part 68 are connected to each other.

Thus, the second intermediate mold runner part 85 connected to the second pot part 18-2 via the second intermediate mold cull part 84 and the cavity forming part 68 are connected to each other by the first intermediate mold runner part 86. Accordingly, the sealing resin flowing from the second pot part 18-2 into the second intermediate mold runner part 85 is supplied to the cavity forming part 69 via the gate part 87 of the first intermediate mold runner part 86.

In the meantime, as shown in FIG. 15, in a position indicated by a line C-C in FIG. 16 through FIG. 19, a piercing hole is formed in parts of the lower mold 62 and the lower mold fixing part 6. A third hollow cylindrical part 17-3 is formed on the external circumferential part of the piercing hole. The third hollow cylindrical part 17-3 can move in a vertical direction by a driving part not shown. A third pot part 18-3 is formed inside the third hollow cylindrical part 17-3. A third plunger 19-3 is provided in the third pot part 18-3. The third plunger part 19-3 can move in a vertical direction by a driving part not shown. An upper part opening hole, namely an opening surface of the third pot part 18-3 of the third hollow cylindrical part 17-3 is connected to a first intermediate mold cull part 88 formed on a lower surface of the first intermediate mold 63. The sealing resin heated and made molten in the third pot part 18-3 flows into the first intermediate mold cull part 88 by movement of the third plunger 19-3.

The first intermediate mold cull part 88 is connected to the first intermediate mold runner part 89 formed on the lower surface of the first intermediate mold 63. Accordingly, the sealing resin flowing into the first intermediate mold cull part 88 by the third plunger 19-3 flows into the first intermediate mold runner part 89. In FIG. 18, lower surfaces of the first intermediate mold cull part 88 and the first intermediate mold runner parts 89 are indicated by dotted lines. In addition, areas of the plural semiconductor elements 12 mounted on the wiring boards 11 in the lower mold 62 provided right under the first intermediate mold 62 are indicated by two-point chain lines.

As shown in FIG. 15, the first intermediate mold runner parts 89 of the first intermediate mold 63 are connected to the lower mold runner parts 90 formed in the lower mold 62.

As shown in FIG. 19, the lower mold runner part 90 has a bear hand-shaped plan configuration. Gate parts 91-1 through 91-6 are provided at portions where the lower mold runner part 90 and the cavity forming part 67 are connected to each other.

Thus, the first intermediate mold runner part 89 connecting to the third pot part 18-3 via the first intermediate mold cull part 88 and the cavity forming part 67 are connected to each other by the lower mold runner part 90. Accordingly, the sealing resin flowing from the third pot part 18-3 into the first intermediate mold runner part 89 is supplied to the cavity forming part 67 via the gate part 91 of the lower mold runner part 90.

Next, a resin sealing method using the mold 60 for resin sealing is discussed with reference to FIG. 13 through FIG. 18.

First, the wiring boards 11 having the main surfaces where plural semiconductor elements 12 are mounted are set on the lower mold 62 fixed to the lower mold fixing part 6 of the resin sealing apparatus, the first intermediate mold 63, and the second intermediate mold 64.

In addition, the first intermediate mold 63 and the second intermediate mold 64 where the wiring boards 11 are set are stacked on the upper mold 61 fixed to the upper mold fixing part 5 and the lower mold 62 fixed to the lower mold fixing part 6.

At this stage, the upper mold 16 and the lower mold 62 are heated by a heating mechanism (not shown) provided at the upper mold fixing part 5 and the lower mold fixing part 6 such as a pressurizing head and stage.

The first intermediate mold 63 is stacked on the lower mold 62. In this embodiment as well as the first embodiment, a solid state sealing resin tablet is lowered down from the opening part of the third hollow cylindrical part 17-3 and is provided on the upper surface of the third plunger 19-3 situated in the lower mold fixing part 6. Next, the second intermediate mold 64 is stacked on the first intermediate mold 63. In this embodiment as well as the first embodiment, a solid state sealing resin tablet is lowered from the opening part of the second hollow cylindrical part 17-2 and is provided on the upper surface of the second plunger 19-2. Next, the upper mold 61 is stacked on the second intermediate mold 64. In this embodiment as well as the first embodiment, a solid state sealing resin tablet is lowered from the opening part of the first hollow cylindrical part 17-1 and is provided on the upper surface of the first plunger 19-1.

After that, mold closing is performed by contacting the upper mold 61 fixed to the upper mold fixing part 5 with the second intermediate mold 64. Then, mold clamping is performed with a designated pressure. In addition, at the same time, the first intermediate mold 63 and the second intermediate mold 64 are heated by a heating mechanism so that the entire mold 10 for resin sealing has an even temperature.

Next, as shown in FIG. 20, each of plungers 19 having upper surfaces where the molten resin 40 are provided go up in a vertical direction by the driving part not shown in FIG. 20. Illustration of the resin is omitted in FIG. 20.

As a result of this, the molten resin is supplied from the upper part opening hole of the first hollow cylindrical part 17-1, namely the opening surface of the first pot part 18-1 to the cavity forming part 69 of the second intermediate mold 64 in the horizontal direction via the upper mold cull part 80, the upper mold runner part 81, the second intermediate mold runner part 82, and the gate part 83. The molten resin is supplied from the upper part opening hole of the second hollow cylindrical part 17-2, namely the opening surface of the second pot part 18-2 to the cavity forming part 68 of the first intermediate mold 63 in the horizontal direction via the second intermediate mold cull part 84, the second intermediate mold runner part 85, the first intermediate mold runner part 86, and the gate part 87. The molten resin is supplied from the upper part opening hole of the third hollow cylindrical part 17-3, namely the opening surface of the third pot part 18-3 to the cavity forming part 67 of the lower mold 62 in the horizontal direction via the first intermediate mold cull part 88, the first intermediate mold runner part 89, the lower mold runner part 90, and the gate part 91. As a result of this, plural semiconductor elements 12 mounted on the wiring boards 11 and the bonding wires 13 are dipped in the sealing resin situated in the cavity forming parts 67 through 69 and are independently formed.

After resin sealing is completed, the mold is opened so that the wiring board 11 having the main surfaces where plural semiconductors 12 and the bonding wires 13 are provided are taken out. Steps after that are the same as those of the first embodiment of the present invention.

Thus, in the second embodiment of the present invention, the resin is independently supplied to the cavity forming part 67 of the lower mold 62 via a resin path formed by the first intermediate mold cull part 88, the first intermediate mold runner part 89, the lower mold runner part 90, and the gate part 91; to the cavity forming part 68 of the first intermediate mold 63 via a resin path formed by the second intermediate mold cull part 84, the second intermediate mold runner part 85, the first intermediate mold runner part 86, and the gate part 87; and to the cavity forming part 69 of the second intermediate mold 64 via the upper mold cull part 80, the upper mold runner part 81, the second intermediate mold runner part 82, and the gate part 83.

Accordingly, it is possible to perform resin molding for every one of cavity forming parts 67 through 69 by differing the resin supplying conditions such as a resin material, an injection condition, an injection timing, and others. Hence, it is possible to easily make the manufacturing yield stable.

For example, it is possible to make thickness (size in the vertical direction) or the configuration of each of the cavity forming parts 67 through 69 vary. By independently supplying the resin to the cavity forming parts having different thicknesses or configurations, it is possible to simultaneously and independently seal the wiring boards 11 having different mounting positions of the semiconductor elements 12 and different sealing configurations. Hence, it is possible to easily make the manufacturing yield stable with a simple structure.

### Third Embodiment

In the first and second embodiments of the present invention, the cavity forming parts 7 and 67 are formed in the lower molds 2 and 62 in addition to the first intermediate molds 3 and 63 and the second intermediate molds 4 and 64. However, the present invention is not limited to these examples. The present invention can be applied to an example where the cavity forming parts are not formed in the upper mold and the lower mold but cavity forming part are formed on only upper and lower surfaces of an intermediate mold sandwiched by the upper mold and the lower mold.

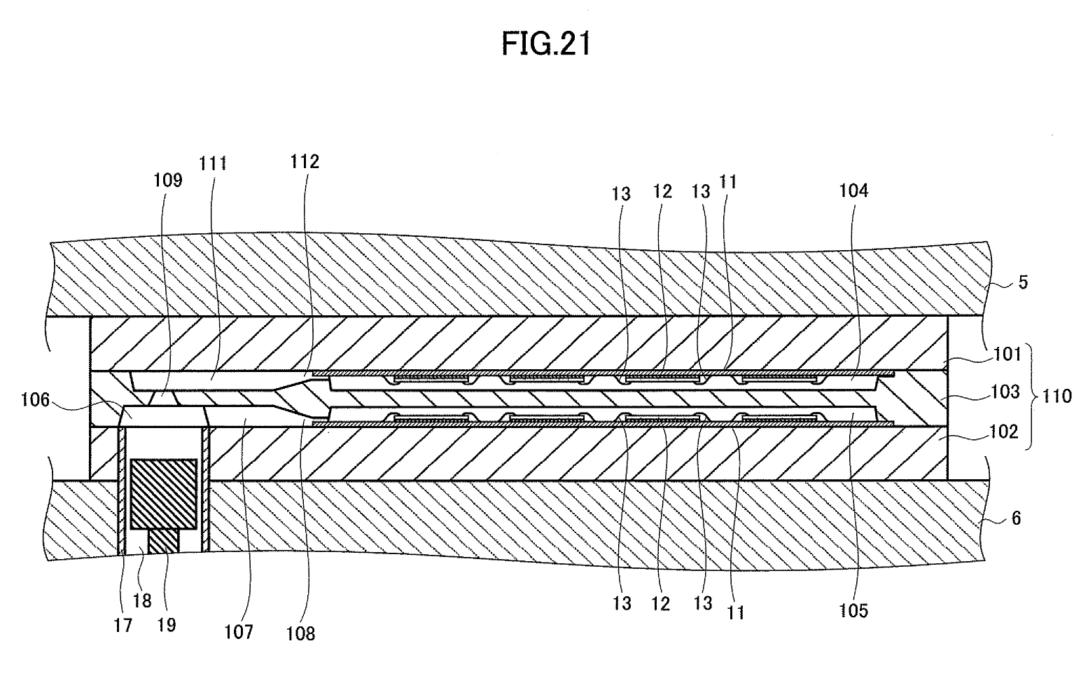

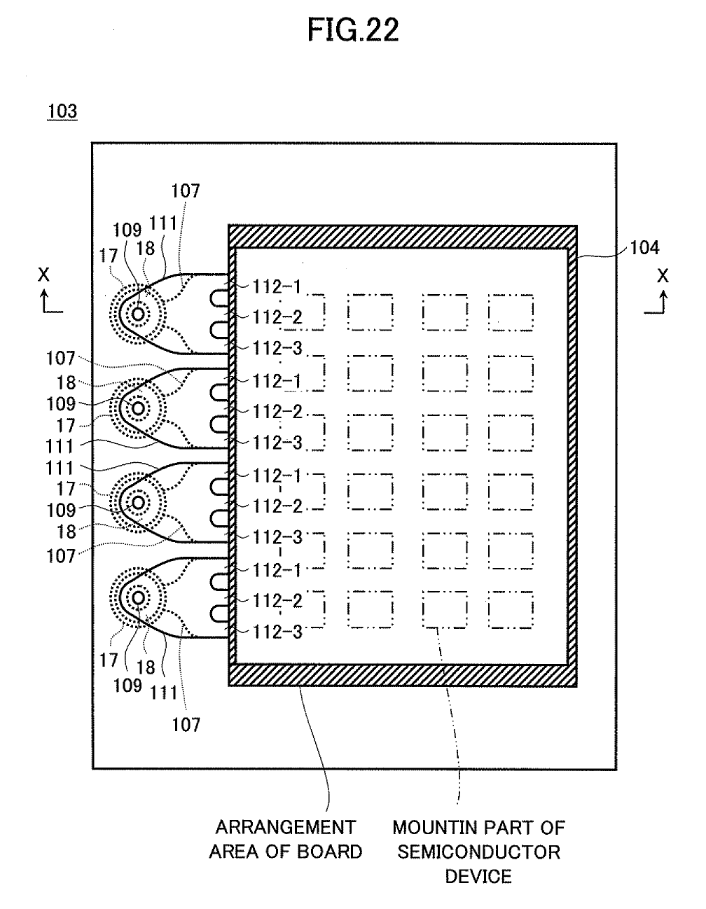

FIG. 21 is a schematic cross-sectional view of a mold for resin sealing provided in a resin sealing apparatus used for a resin sealing method of an electronic component of a third embodiment of the present invention. FIG. 22 is a plan view of an intermediate mold 103 shown in FIG. 21. FIG. 21 is a cross-sectional view taken along line X-X of FIG. 20.

In FIG. 21 and FIG. 22, parts that are the same as the parts shown in FIG. 1 through FIG. 12 are given the same reference numerals, and explanation thereof is omitted. In addition, areas of the wiring board 11 where plural semiconductor elements 12 are provided are indicated by two-point chain lines.

Referring to FIG. 21 and FIG. 22, a mold 110 for resin sealing of the third embodiment of the present invention includes an upper mold 101, a lower mold 102, and an intermediate mold 103. Each of the upper mold 101, the lower mold 102, the intermediate mold 103 has a substantially same area.

The upper mold 101 is fixed to an upper mold fixing part 5 of a resin sealing apparatus. The lower mold 102 is fixed to a lower mold fixing part 6 of the resin sealing apparatus. The intermediate mold 103 is stacked on the lower mold 102. The upper mold 101 is provided on the intermediate mold 103.

Positioning between the intermediate mold 103 and the upper mold 101 and the lower mold 102 is made by engaging pins (not shown) provided on the upper mold 101 and the lower mold 102 with hole forming parts of the intermediate mold 103.

Concave shaped cavity forming parts 104 and 105 are formed in upper and lower surfaces of the intermediate mold 103.

The wiring boards 11 are provided in the cavity forming parts 104 and 105 so that the plural semiconductor elements 12 mounted on the main surfaces of the wiring boards 11 and the bonding wires 13 connecting outside connection terminals of the semiconductor elements 12 and electrode terminals on the wiring boards 11 are situated inside the cavity forming parts 104 and 105. The upper and lower surfaces of the intermediate mold 103 are situated in the same position as the rear surface of the wiring boards 11.

Molten resin is injected (supplied) into the cavity forming parts 104 and 105 so that plural semiconductor elements 12 mounted on the wiring board 11 and the bonding wires 13 are sealed by the resin.

A piercing hole is formed in parts of the lower mold 102 and the lower mold fixing part 6. A hollow cylindrical part 17 is formed on the external circumferential part of the piercing hole. The hollow cylindrical part 17 can move in a vertical direction by a driving part not shown. A pot part 18 is formed inside the hollow cylindrical part 17. A plunger 19 is provided in the pot part 18. The plunger part 19 can move in a vertical direction by a driving part not shown. An upper part opening hole, namely an opening surface of the pot part 18 of the first hollow cylindrical part 17 is connected to plural cull parts 106 formed in the lower surface of the intermediate mold 103. The sealing resin heated and made molten in the pot part 18 flows into the upper mold cull parts 106 due to movement by the plunger 19.

The cull parts 106 are connected to intermediate mold lower part runner part 107 formed on the lower surface of the intermediate mold 103. Accordingly, the sealing resin flowing into the cull part 106 due to movement by the plunger 19 flows into the intermediate mold lower part runner part 107. In FIG. 22, lower surfaces of the cull part 106 and the intermediate mold lower part runner part 107 are indicated by dotted lines.

The intermediate mold lower part runner part 107 has a bear hand-shaped plan configuration. Gate parts 108 are provided at portions where the intermediate mold lower part runner part 107 and the cavity forming part 105 are connected to each other.

The intermediate mold lower part runner part 107 in communication with the pot part 18 via the cull part 106 are in communication with the cavity forming part 105. Accordingly, the sealing resin flowing from the pot part 18 to the intermediate mold lower part runner part 107 flows to the cavity forming part 105 via the gate part 108 of the intermediate mold lower part runner part 107.

The piercing runner part 109 piercing the intermediate mold 103 in the vertical direction is connected to the cull part 106. The piercing runner part 109 is in communication with the intermediate mold upper part runner part 111 formed on the upper surface of the intermediate mold 103. Accordingly, the sealing resin flowing to the cull part 106 by movement of the plunger 19 flows in the intermediate mold upper part runner part 111. The piercing runner part 109 has a cross section where the piercing runner part 109 tapers off toward the upper surface of the intermediate mold 103.

The intermediate mold upper part runner part 111 has a bear hand-shaped plan configuration. Gate parts 112-1 through 112-3 are provided at portions where the intermediate mold upper part runner part 111 and the cavity forming part 104 are connected to each other.

The intermediate mold upper part runner part 111 in communication with the pot part 18 via the cull part 106 and the piercing runner part 109 are in communication with the cavity forming part 104. Accordingly, the sealing resin flowing from the pot part 18 to the intermediate mold upper part runner part 111 flows into the cavity forming part 104 via the gate part 112 of the intermediate mold upper part runner part 111.

Next, a resin sealing method using the mold 110 for resin sealing is discussed with reference to FIG. 21.

First, the wiring board 11 having the main surface where plural semiconductor elements 12 are mounted is set in the lower mold 2 fixed to the lower mold fixing part 6. Positioning of the wiring board 11 relative to the lower mold 102 is made by engaging the pin provided on the lower mold 102 and the hole forming part formed in the wiring board 11.

At this stage, the upper mold 101 and the lower mold 102 are heated by a heating mechanism (not shown) provided at the upper mold fixing part 5 and the lower mold fixing part 6 such as a pressurizing head and stage.

In this embodiment as well as the first embodiment, solid state sealing resin tablet is lowered from the opening part of the hollow cylindrical part 17 and is provided on the upper surface of the plunger 19 situated in the lower mold fixing part 6.

Next, the wiring board 11 having the main surface where plural semiconductor elements 12 are mounted is set on the upper surface of the intermediate mold 103. The intermediate mold 103 where the wiring board 11 is set is provided between the upper mold 101 fixed to the upper mold fixing part 5 and the lower mold 102 fixed to the lower mold fixing part 6.

After that, mold closing is performed by contacting the upper mold 101 fixed to the upper mold fixing part 5 with the intermediate mold 103. Then, mold clamping is performed with a designated pressure. In addition, at the same time, the intermediate mold 103 is heated by a heating mechanism so that the entire mold 110 for resin sealing has an even temperature.

Next, the plungers 19 having the upper surface where the molten resin 40 is provided are raised in a vertical direction by movement of the driving part not shown. As a result of this, the molten resin is supplied from the upper part opening hole of the hollow cylindrical part 17, namely the opening surface of the pot part 18 to the cavity forming part 105 in the horizontal direction via the cull part 106 and the gate part 108 of the intermediate mold lower runner part 107 and to the cavity forming part 112 in the horizontal direction via the cull part 106, the piercing runner part 109 and the gate part 112 of the intermediate mold upper runner part 111.

As a result of this, plural semiconductor elements 12 mounted on the wiring boards 11 and the bonding wires 13 are dipped in the sealing resin 104 and 105 and are independently formed.

After resin sealing is completed, the mold is opened so that the wiring board 11 having the main surface where plural semiconductors 12 and the boding wires 13 are provided is taken out. Steps after that are the same as those of the first embodiment of the present invention.

Thus, in the third embodiment of the present invention, the cavity forming parts are not in the upper mold 101 and the lower mold 102. The cavity forming parts 104 and 105 are formed in the upper and lower surfaces of the intermediate mold 103 sandwiched by the upper mold 101 and the lower mold 102. The resin supplied from the pot part 18 as a single resin supplying source via the cull part 106 is supplied to the cavity forming parts 104 and 105 via resin paths.

Accordingly, it is possible to seal the wiring boards 11 provided in the upper and lower surfaces of the intermediate molds 103 simultaneously and thereby manufacturing efficiency in the resin sealing step can be improved with a simple structure.

### Fourth Embodiment

As discussed above, in the third embodiment of the present invention, the cavity forming parts are not in the upper mold 101 and the lower mold 102. The cavity forming parts 104 and 105 are formed in the upper and lower surfaces of the intermediate mold 103 sandwiched by the upper mold 101 and the lower mold 102. The resin supplied from the pot part 18 as a single resin supplying source via the cull part 106 is supplied to the cavity forming part 104 and 105 via resin paths. However, the present invention is not limited to these examples. The present invention can be applied to an example where the molten resin is independently supplied to the cavity forming parts 104 and 105 formed in the upper and lower surfaces of the intermediate mold 103.

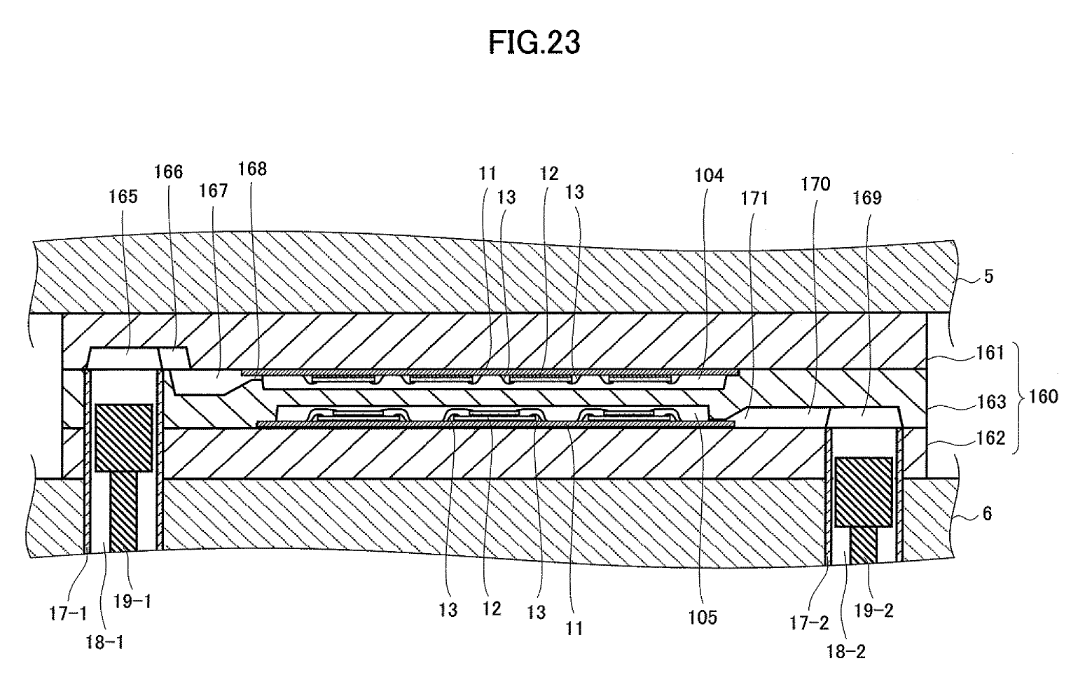

FIG. 23 is a schematic cross-sectional view of a mold for resin sealing provided in a resin sealing apparatus used for a resin sealing method of an electronic component of a fourth embodiment of the present invention. In FIG. 23, parts that are the same as the parts shown in FIG. 1 through FIG. 12 are given the same reference numerals, and explanation thereof is omitted.

Referring to FIG. 23, a mold 160 for resin sealing of this embodiment of the present invention includes an upper mold 161, a lower mold 162, and an intermediate mold 163. Each of the upper mold 161, the lower mold 162, and the intermediate mold 163 has a substantially same area.

The upper mold 161 is fixed to an upper mold fixing part 5 of a resin sealing apparatus. The lower mold 162 is fixed to a lower mold fixing part 6 of the resin sealing apparatus. The intermediate mold 163 is stacked on the lower mold 162. The upper mold 161 is provided on the intermediate mold 163.

Positioning between the intermediate mold 163 and the upper mold 161 and the lower mold 162 is made by engaging pins (not shown) provided on the upper mold 161 and the lower mold 162 with hole forming parts of the intermediate mold 163.

Concave shaped cavity forming parts 104 and 105 are formed in upper and lower surfaces of the intermediate mold 163.

The wiring boards 11 are provided in the cavity forming parts 104 and 105 so that the plural semiconductor elements 12 mounted on the main surfaces of the wiring boards 11 and the bonding wires 13 connecting outside connection terminals of the semiconductor elements 12 and electrode terminals on the wiring boards are situated inside the cavity forming parts 104 and 105. The upper and lower surfaces of the intermediate mold 163 are situated in the same position as the rear surface of the wiring boards 11.

Molten resin is injected (supplied) into the cavity forming parts 104 and 105 so that plural semiconductor elements 12 mounted on the wiring board 11 and the bonding wires 13 are sealed by the resin.

At left side parts of the cavity forming parts 104 and 105 in FIG. 23, a piercing hole is formed in the lower mold 162, the intermediate mold 163, and the lower mold fixing part 6. A first hollow cylindrical part 17-1 is formed on the external circumferential part of the piercing hole. The first hollow cylindrical part 17-1 can move in a vertical direction by a driving part not shown. A first pot part 18-1 is formed inside the first hollow cylindrical part 17-1. A first plunger 19-1 is provided in the first pot part 18-1. The first plunger part 19-1 can move in a vertical direction by a driving part not shown. An upper part opening hole, namely an opening surface of the first pot part 18-1 of the first hollow cylindrical part 17-1 is connected to the upper mold cull part 165 formed in the lower surface of the upper mold 161. The sealing resin heated and made molten in the first pot part 18-1 flows into the upper mold cull part 165 by movement of the first plunger 19-1.

The upper mold cull part 165 is connected to an intermediate mold lower part runner part 166 formed on the lower surface of the upper mold 161. Accordingly, the sealing resin flowing into the upper mold cull part 165 by movement of the first plunger 19-1 flows into the upper mold runner part 166. The upper mold runner part 166 of the upper mold 161 is in communication with a first intermediate mold runner part 167 formed in the intermediate mold 163. A gate part is provided as a connection part of the first intermediate mold runner part 167 and the cavity forming part 104.

Thus, the upper mold runner part 166 communication with the first pot part 18-1 via the upper mold cull part 165 and the cavity forming part 104 are in communication with each other via the first intermediate mold runner part 167. Accordingly, the sealing resin flowing from the first pot part 18-1 to the upper mold runner part 166 is supplied to the cavity forming part 104 via the gate part 168 of the first intermediate mold runner part 167.

At right side parts of the cavity forming parts 104 and 105 in FIG. 23, a piercing hole is formed in the lower mold 162 and the lower mold fixing part 6.

A second hollow cylindrical part 17-2 is formed on the external circumferential part of the piercing hole. The second hollow cylindrical part 17-2 can move in a vertical direction by a driving part not shown. A second pot part 18-2 is formed inside the second hollow cylindrical part 17-2. A second plunger 19-2 is provided in the second pot part 18-2. The second plunger part 19-2 can move in a vertical direction by a driving part not shown. An upper part opening hole, namely an opening surface of the second pot part 18-2 of the second hollow cylindrical part 17-2 is connected to an intermediate mold cull part 169 formed in the lower surface of the intermediate mold 163. The sealing resin heated and made molten in the second pot part 18-2 flows into the intermediate mold cull part 169 by movement of the second plunger 19-2.

The intermediate mold cull part 169 is connected to a second intermediate mold runner part 170 formed on the lower surface of the intermediate mold 163. Accordingly, the sealing resin flowing into the intermediate mold cull part 169 by the movement of the second plunger 19-1 flows into the second intermediate mold runner part 170. A gate part 171 is provided a connection part of the second intermediate mold runner part 170 and the cavity forming part 105.

Thus, the second intermediate mold runner part 170 in communication with the second pot part 18-2 via the intermediate mold cull part 169 and the cavity forming part 105 are in communication with each other. Accordingly, the sealing resin flowing from the second pot part 18-2 to the intermediate mold cull part 169 is supplied to the cavity forming part 105 via the gate part 171 of the second intermediate mold runner part 170.

Next, a resin sealing method using the mold 160 for resin sealing is discussed.

First, the wiring board 11 having the main surface where plural semiconductor elements 12 are mounted is set in the lower mold 162 fixed to the lower mold fixing part 6. Positioning of the wiring board 11 to the lower mold 162 is made by engaging the pin provided on the lower mold 162 and the hole forming part formed in the wiring board 11.

At this stage, the upper mold 161 and the lower mold 162 are heated by a heating mechanism (not shown) provided at the upper mold fixing part 5 and the lower mold fixing part 6 such as a pressurizing head and stage.

A solid state sealing resin tablet is lowered from the opening part of the second hollow cylindrical part 17-2 and is provided on the upper surface of the plunger 19-2 situated in the lower mold fixing part 6.

Next, the wiring board 11 having the main surface where plural semiconductor elements 12 are mounted is set on the upper surface of the intermediate mold 163. The intermediate mold 163 where the wiring board 11 is set is provided between the upper mold 161 fixed to the upper mold fixing part 5 and the lower mold 162 fixed to the lower mold fixing part 6.

In addition, a solid state sealing resin tablet is lowered from the opening part of the first hollow cylindrical part 17-1 and is provided on the upper surface of the first plunger 19-1 situated in the lower mold fixing part 6.

After that, mold closing is performed by contacting the upper mold 161 fixed to the upper mold fixing part 5 with the intermediate mold 163. Then, mold clamping is performed with a designated pressure. In addition, at the same time, the intermediate mold 163 is heated by a heating mechanism so that the entire mold 160 for resin sealing has an even temperature.

Next, the plunger 19 having the upper surface where the molten resin 40 is provided is raised in a vertical direction by the driving part not shown.

As a result of this, the molten resin is supplied from the upper part opening hole of the first hollow cylindrical part 17-1, namely the opening surface of the pot part 18-1 to the cavity forming part 104 in the horizontal direction via the upper mold cull part 165, the upper mold runner part 166, the first intermediate mold runner part 167, and the gate part 168 and supplied from the upper part opening hole of the second hollow cylindrical part 17-2, namely the opening surface of the pot part 18-2 to the cavity forming part 105 in the horizontal direction via the intermediate mold cull part 169, the intermediate mold runner part 170, and the gate part 171.

As a result of this, plural semiconductor elements 12 mounted on the wiring boards 11 and the bonding wires 13 are dipped in the sealing resin 104 and 105 and are independently formed.

After resin sealing is completed, the mold is opened so that the wiring board 11 having the main surfaces where plural semiconductors 12 and the bonding wires 13 are provided are taken out. Steps after that are the same as those of the first embodiment of the present invention.

Thus, in the fourth embodiment of the present invention, the cavity forming parts are not in the upper mold 161 and the lower mold 162. The cavity forming parts 164 and 165 are formed in the upper and lower surfaces of the intermediate mold 163 sandwiched by the upper mold 161 and the lower mold 162. The resin is independently supplied to the cavity forming part 104 and 105 via independent resin paths.

Accordingly, it is possible to seal the wiring boards 11 provided in the upper and lower surfaces of the intermediate molds 163 simultaneously and thereby manufacturing efficiency in the resin sealing step can be improved with a simple structure.

In addition, in this embodiment, since the molten resin is independently supplied to the cavity forming parts 104 and 105, it is possible to perform resin molding for each of the cavity forming parts 104 and 105 by differing the resin supplying conditions such as a resin material, an injection condition, an injection timing, and others. Hence, it is possible to easily make the manufacturing yield stable.

For example, it is possible to vary the thickness (size in the vertical direction) or configuration of each of the cavity forming parts 104 and 105. By independently supplying the resin to the cavity forming parts 104 and 015 having different thicknesses or configurations, it is possible to simultaneously and independently seal the wiring boards 11 having different mounting positions of the semiconductor elements 12 and different sealing configurations. Hence, it is possible to easily make the manufacturing yield stable with a simple structure.

### Fifth Embodiment

In the above-discussed embodiments, only a single surface of the wiring board where the semiconductor elements are mounted is sealed by the molten resin. However, the present invention is not limited to this example. The present invention can be applied to an example where both surfaces of the lead frame as a sheet member where the semiconductor elements are mounted are sealed by molten resin.

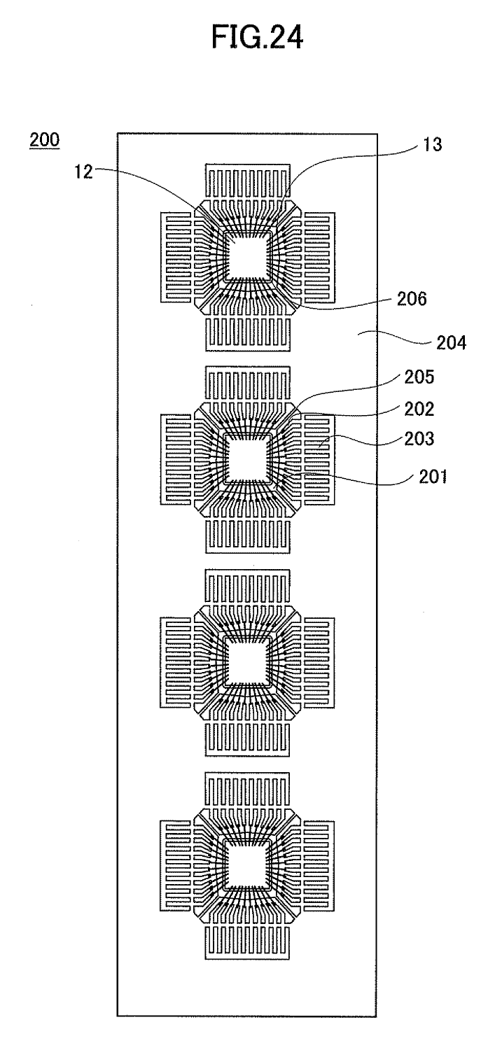

FIG. 24 is a plan view of a lead frame where semiconductor elements are mounted used in the fifth embodiment of the present invention.

Referring to FIG. 24, a lead frame 200 used in the fifth embodiment of the present invention is made of, for example, a copper alloy, an iron and nickel alloy, or the like. A die pad (die stage) 201, an inner lead part 202, and outer lead part 203 are formed in the lead frame 200 by etching or punching using a mold. The outer lead part 203 formed outside of the inner lead part 202 works as an outside connection terminal and is connected to the inner lead part 202. Furthermore, the die pad (die stage) 201 is supported by a die pad supporting part 205 connected to a periphery frame part 204. The semiconductor element 12 is adhered and fixed on the die pad (die stage) via an adhesive 206.

In the fifth embodiment of the present invention, the lead frame 200 where the semiconductor elements 12 are mounted is arranged in a mold for resin sealing.

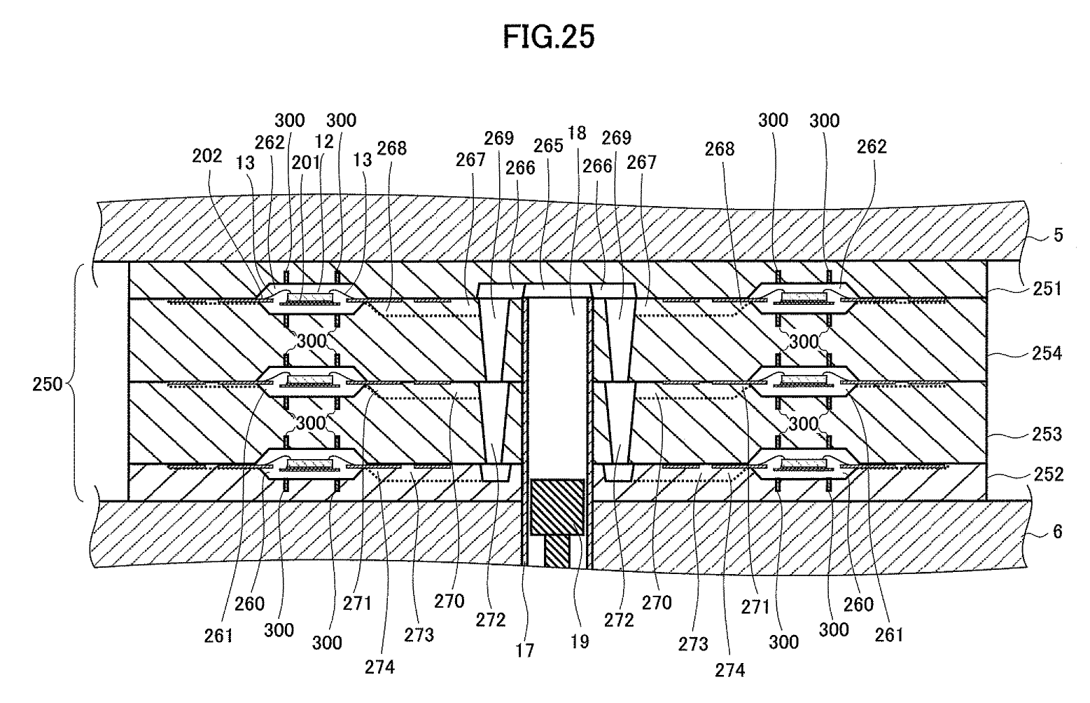

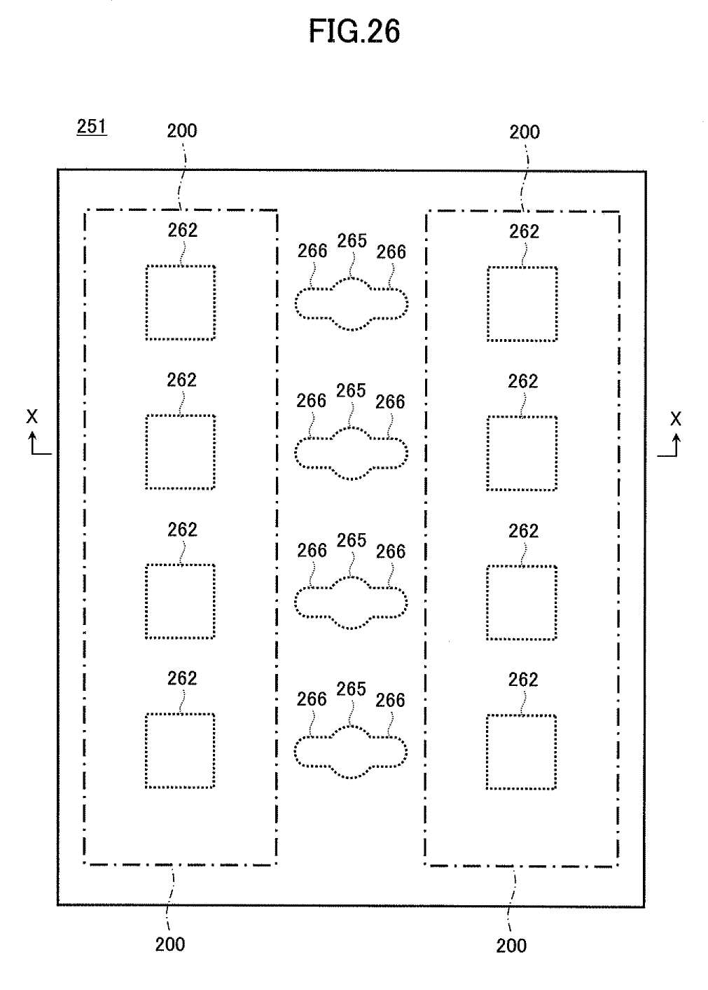

FIG. 25 is a schematic cross-sectional view of a mold for resin sealing provided in a resin sealing apparatus used for a resin sealing method of an electronic component of the fifth embodiment of the present invention. FIG. 25 is a cross-sectional view taken along a line X-X of FIG. 26 through FIG. 29.

Referring to FIG. 25, a mold 250 for resin sealing of this embodiment of the present invention includes an upper mold 251, a lower mold 252, and a first intermediate mold 253, and a second intermediate mold 254. Each of the upper mold 251, the lower mold 252, the first intermediate mold 253, and the second intermediate mold 254 has a substantially same area.

The upper mold 251 is fixed to an upper mold fixing part 5 of a resin sealing apparatus. The lower mold 252 is fixed to a lower mold fixing part 6 of the resin sealing apparatus. The first intermediate mold 253 is stacked on the lower mold 252. The second intermediate mold 254 is stacked on the first intermediate mold 253. The upper mold 251 is provided on the second intermediate mold 254.

Positioning between the first and second intermediate molds 253 and 254 and the upper mold 251 and the lower mold 252 is made by engaging pins (not shown) provided on the upper mold 251 and the lower mold 252 with hole forming parts of the first and second intermediate molds 253 and 254.

A piercing hole is formed in the center of the first intermediate mold 253, the second intermediate mold 254, and the lower mold 252. A first hollow cylindrical part 17 is formed on the external circumferential part of the piercing hole. The first hollow cylindrical part 17 can move in a vertical direction by a driving part not shown. At left and right sides of the hollow cylindrical part 17, cavity forming parts 260 are formed in the upper surface of the lower mold 252 and the lower surface of the first intermediate mold 253, a cavity forming part 261 is formed in the lower surface of the second intermediate mold 254 and the upper surface of the first intermediate mold 253, and a cavity forming part 262 is formed in the upper surface of the second intermediate mold 254 and the lower surface of the upper mold 251.

The lead frame 200 is provided on upper surfaces of the lower mold 252, the first intermediate mold 253, and the second intermediate mold 254 so that the semiconductor elements mounted on the die pad (die stage) 201 of the lead frame 200 as a sheet member, the inner lead part 202, and the bonding wires connecting the semiconductor elements 12 and the inner lead parts 202 are positioned inside the cavity forming parts 260 through 262. In FIG. 25, for the convenience of seeing drawings, numerical references of parts of a cavity forming part 262 positioned in most upper left part are omitted.

Molten resin is injected (supplied) into the cavity forming parts 260 through 262 so that plural semiconductor elements 12 mounted on the die pad (die stage) 201 of the lead frame, the inner lead part 202, and the bonding wires 13 connecting the semiconductor elements 12 and the inner lead part 202 are sealed by the resin.

A pot part 18 is formed inside the hollow cylindrical part 17. The plunger 19 is provided in the pot part 18. The plunger part 19 can move in a vertical direction by a driving part not shown. An upper part opening hole, namely an opening surface of the pot part 18 of the hollow cylindrical part 17 is connected to the upper mold cull part 265 formed in the lower surface of the upper mold 251. The sealing resin heated and made molten in the pot part 18 flows into the upper mold cull part 265 by movement of the plunger 19.

Next, FIG. 26 in addition to FIG. 25 is referred to. FIG. 26 is a plan view of the upper mold 251 shown in FIG. 25. In FIG. 26, areas on the second intermediate mold 254 where the lead frames 200 are provided are indicated by two-point chain lines.

Referring to FIG. 25 and FIG. 26, the cull part 265 formed in the lower surface of the upper mold 251 is connected to upper mold runner parts 266 formed at the right and left sides of the cull part 265 and in the lower surface of the upper mold 251. Accordingly, sealing resin flowing from the plunger 19 to the cull part 265 flows in the upper mold runner parts 266.

In FIG. 26, areas of the cavity forming parts 262 in the lower surface of the cull parts 265, the lower surface of the upper mold runner parts 266, and the second intermediate mold 254 provided right under the upper mold 251 are indicated by dotted lines.

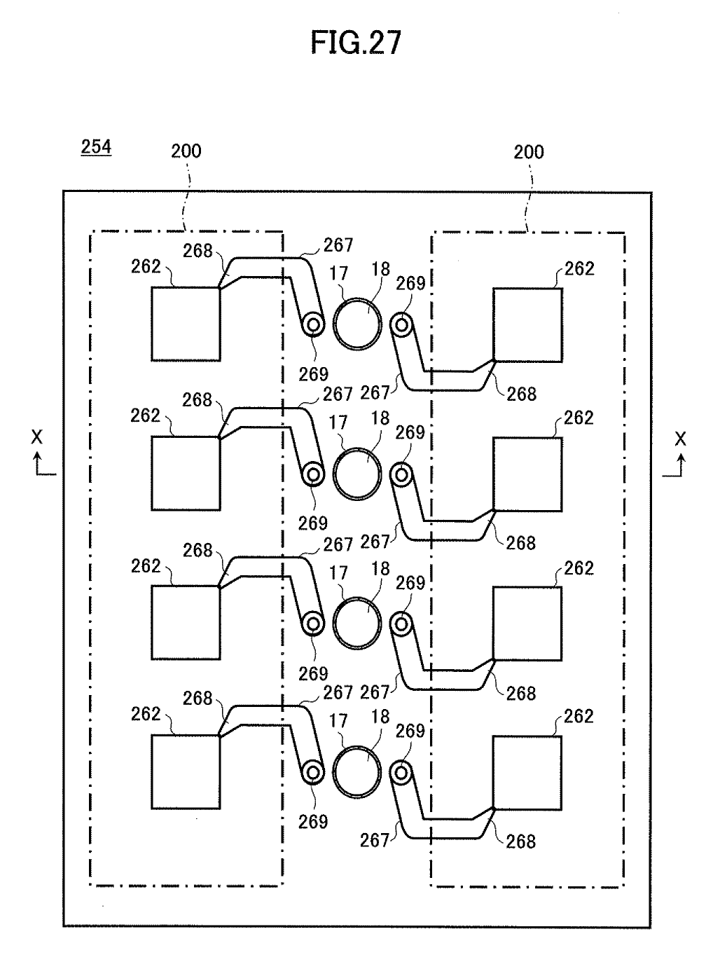

Next, FIG. 27 in addition to FIG. 25 is referred to. FIG. 27 is a plan view of the second intermediate mold 254 shown in FIG. 25. In FIG. 27, areas on the lead frame 200 on the second intermediate mold 254 are provided as indicated by two-point chain lines.

Referring to FIG. 25 and FIG. 27, the upper mold runner parts 266 of the upper mold 251 are in communication with the second intermediate mold runner parts 267 formed in the second intermediate mold 254. Gate parts 268 are provided as connection parts of the second intermediate mold runner parts 267 and the cavity forming parts 262.

Second intermediate mold piercing runner parts 269 are provided at the second intermediate mold runner parts 267 so as to pierce the second intermediate mold 254.

The second intermediate mold piercing runner parts 269 have a cross section where the second intermediate mold piercing runner part 269 tapers off toward the lower surface of the second intermediate mold 254. The gate part 268 of the second intermediate mold runner part 267 inclines upward.

Thus, the upper mold runner parts 266 in communication with the pot part 18 via the cull parts 265 and the cavity forming parts 262 are in communication with each other via the second intermediate mold runner parts 267. Accordingly, the sealing resin flowing from the pot part 18 to the left and right upper mold runner parts 266 is supplied to the left and right cavity forming parts 262 via the gate parts 268 of the second intermediate mold runner parts 267 and to the second intermediate mold piercing runner parts 269.

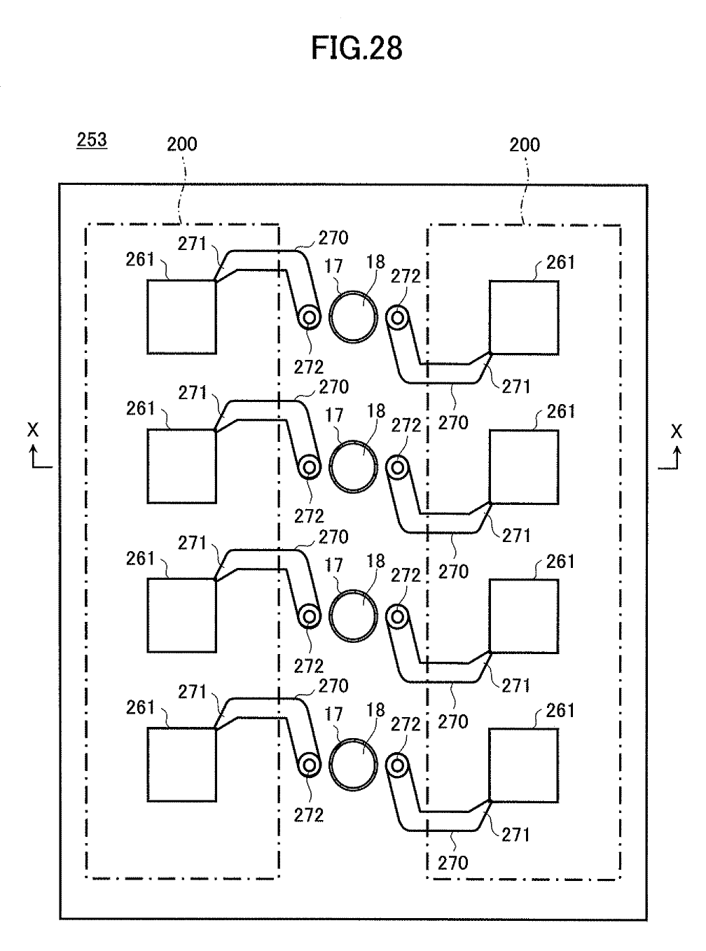

Next, FIG. 28 in addition to FIG. 25 is referred to. FIG. 28 is a plan view of the first intermediate mold 253 shown in FIG. 25. In FIG. 28, areas on the lead frame 200 on the first intermediate mold 253 are provided as indicated by two-point chain lines.

Referring to FIG. 25 and FIG. 28, the second intermediate mold piercing runner part 269 of the second intermediate mold 254 are in communication with the first intermediate mold runner parts 270 formed in the first intermediate mold 253. The gate parts 271 are provided at parts where the first intermediate mold runner parts 270 and the cavity forming parts 261 are connected to each other.

In addition, the first intermediate mold piercing runner parts 272 are connected to the first intermediate mold runner parts 270 so as to pierce the first intermediate mold 253.

The first intermediate mold piercing runner part 272 has a cross section where the first intermediate mold piercing runner part 272 tapers off toward the lower surface of the first intermediate mold 253. The gate part 271 of the first intermediate mold runner part 270 inclines upward.

Thus, the upper mold runner parts 266 in communication with the pot part 18 via the cull part 265 and the cavity forming parts 261 are in communication with each other via the second intermediate mold piercing runner parts 269 of the second intermediate mold 254 and the first intermediate mold runner parts 270.

Accordingly, the sealing resin flowing from the pot part 18 to the left and right upper mold runner parts 266 is supplied to the left and right cavity forming parts 261 in the horizontal direction via the second intermediate mold piercing runner parts 269 of the second intermediate mold 254, the first intermediate mold runner parts 270, and the gate parts 271 and flows in the first intermediate mold piercing runner parts 272.

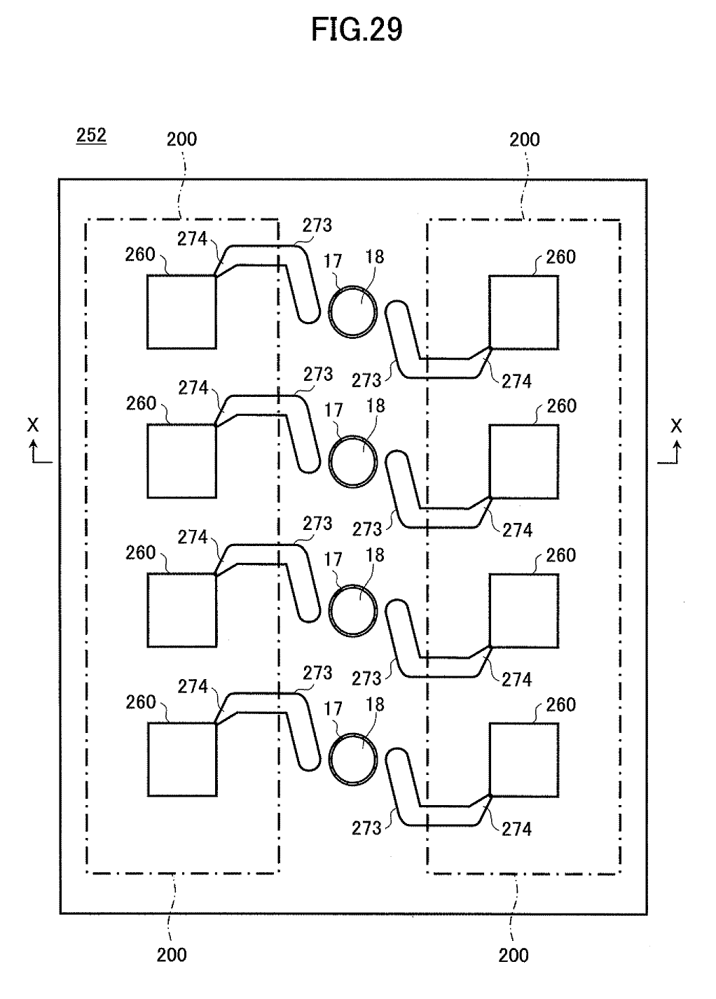

Next, FIG. 29 in addition to FIG. 25 is referred to. FIG. 29 is a plan view of the lower mold 252 shown in FIG. 25. In FIG. 29, areas on the lead frame 200 on the lower mold 252 are provided are indicated by two-point chain lines.

Referring to FIG. 25 and FIG. 29, the first intermediate mold piercing runner parts 272 are in communication with the lower mold runner parts 273 formed in the lower mold 252. The gate parts 274 are provided at parts where the lower mold runner parts 273 and the cavity forming parts 274 are connected to each other.

The gate parts 274 of the lower mold runner parts 273 incline upward.

Thus, the first intermediate mold runner parts 270 in communication with the pot part 18 via the cull part 265, the upper mold runner parts 266, and the second intermediate mold piercing runner part 269 and the cavity forming parts 260 are in communication with each other via the first intermediate mold piercing runner parts 272 and the lower mold runner parts 273.

Accordingly, the sealing resin flowing from to the first intermediate mold runner parts 272 of the first intermediate mold 253 is supplied to the cavity forming parts 260 in the horizontal directions via the gate parts 274 of the lower mold runner parts 273.

In the meantime, as shown in FIG. 25, two eject pins 300 are provided in the upper mold 251 so as to be capable of projecting from the upper surface of the cavity forming parts 262, in the second intermediate mold 254 so as to be capable of projecting from the lower surfaces of the cavity forming parts 262 and the upper surface of the cavity forming parts 261, in the first intermediate mold 253 so as to be capable of projecting from the lower surfaces of the cavity forming parts 261 and the upper surfaces of the cavity forming parts 260, and in the lower mold 252 so as to be capable of projecting from the lower surfaces of the cavity forming parts 260.

After resin sealing is completed, the lead frame 200 is taken out from the mold 250 for resin sealing by an eject mechanism.

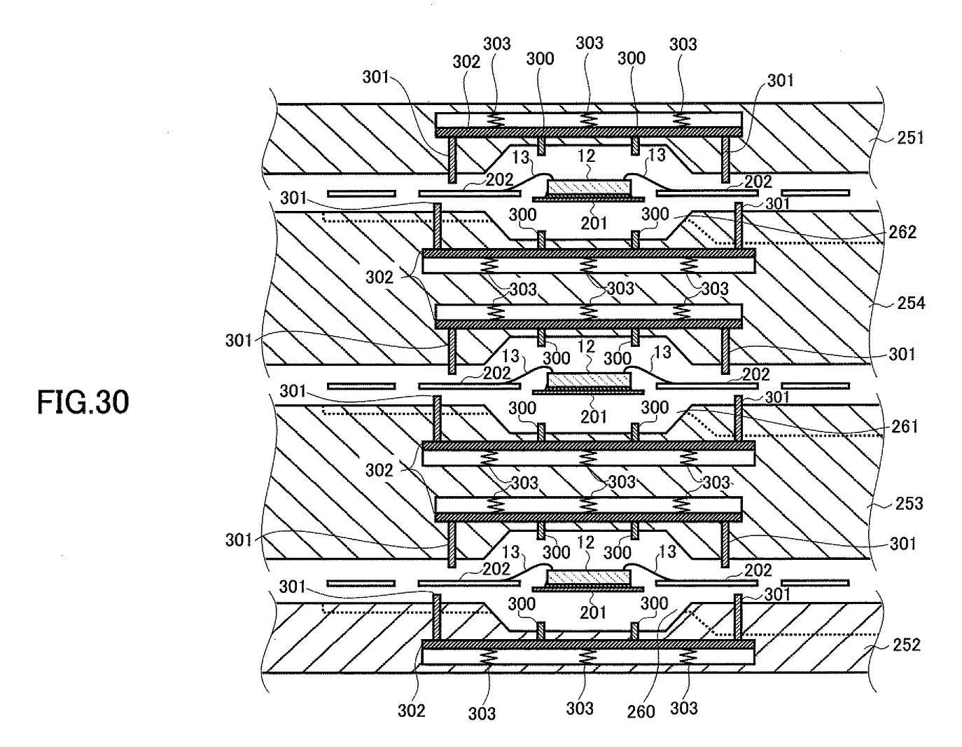

A structure of the eject mechanism by using the eject pins 300 is discussed with reference to FIG. 30. FIG. 30 is a view for explaining the structure of the eject mechanism using eject pins 300. FIG. 30 is an expanded view of the cavity forming parts 260 through 262 and vicinities thereof.

Referring to FIG. 30, the eject mechanism of this embodiment includes two eject pins 300 and two column parts 301 for sending.

The eject pins 300 and the column parts 301 are supported by and fixed to the plate shaped ejector pin supporting part 302. Inside the mold, the eject pin supporting part 302 is elastically supported by three compression springs 303. In a state where the upper mold 251, the second intermediate mold 254, the first intermediate mold 253, and the lower mold 252 do not contact each other and are separated from each other, the eject pins 300 project from the cavity forming parts 260 through 262 and the column parts 301 project from surfaces where the upper mold 251, the second intermediate mold 254, the first intermediate mold 253, and the lower mold 252 will make contact with each other, as shown in FIG. 30.

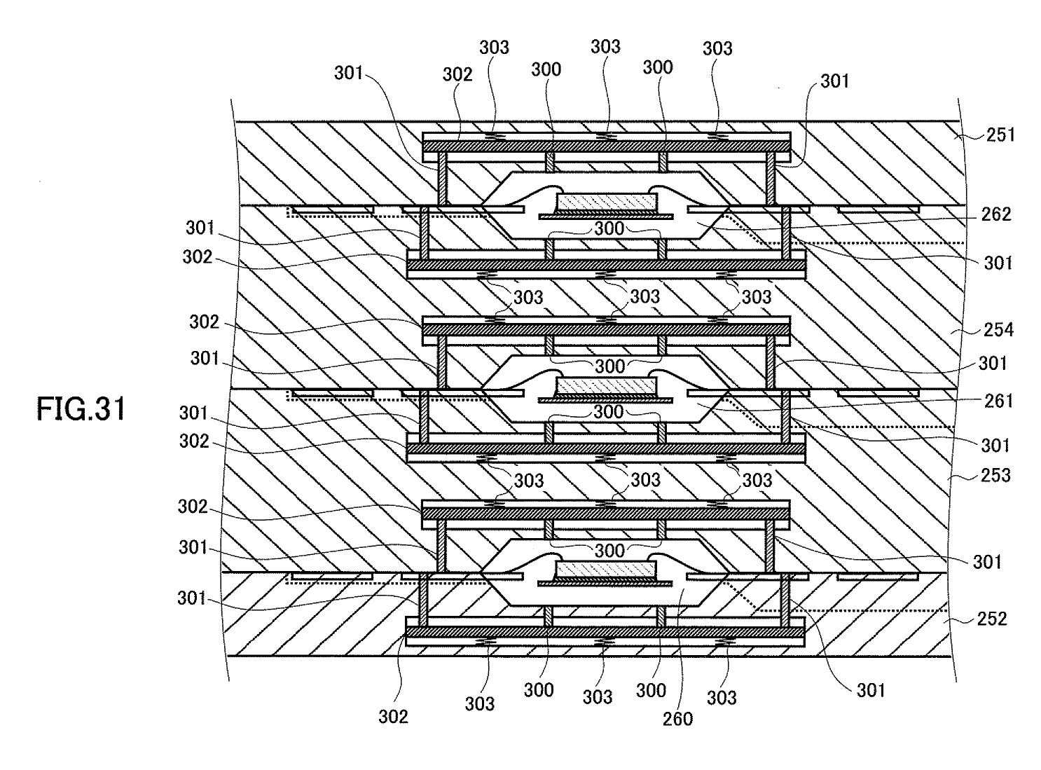

Next, a resin sealing method using the mold 250 for resin sealing and operations of the eject mechanism using the eject pins 300 are discussed with reference to FIG. 26 and FIG. 31 through FIG. 34. Here, FIG. 31 through FIG. 34 are first through fourth views for explaining a resin sealing method using the mold 250 for resin sealing shown in FIG. 25.

Referring to FIG. 25, the lead frame 200 where the semiconductor elements 12 are mounted is provided on upper surfaces of the lower mold 252, the first intermediate mold 253, and the second intermediate mold 254. The semiconductor elements 12 mounted on the lead frame 200 and the bonding wires 13 are positioned inside the cavity forming parts 260 through 262.

In addition, the first intermediate mold 253 and the second intermediate mold 254 where the lead frames 200 are set are provided between the upper mold 251 fixed to the upper mold fixing part 5 and the lower mold 252 fixed to the lower mold fixing part 6.

More specifically, the first intermediate mold 253 is stacked on the lower mold 252. The second intermediate mold 254 is stacked on the first intermediate mold 253. Positioning between the first and second intermediate molds 253 and 254 and the upper mold 251 and the lower mold 252 is made by engaging pins (not shown) provided on the upper mold 251 and the lower mold 252 with hole forming parts of the first and second intermediate molds 253 and 254.

At this stage, the upper mold 261 and the lower mold 262 are heated by a heating mechanism (not shown) provided at the upper mold fixing part 5 and the lower mold fixing part 6 such as a pressurizing head and stage.

In addition, at this stage, the upper surface of the hollow cylindrical part 17 which can move in the vertical direction in the lower mold 252, the first intermediate mold 253, and the second intermediate mold 254 is situated in the same position as the upper surface of the lower mold 252.

Next, in a state where the first intermediate mold 253 is stacked on the lower mold 252 and the second intermediate mold 254 is stacked on the first intermediate mold 253, the hollow cylindrical part 17 is raised in the vertical direction by the driving part (not shown) until the upper surface of the hollow cylindrical part 17 is situated in the same position of the upper surface of the second intermediate mold 254. As a result of this, the pot parts 18 are in communication with each other in the lower mold 252, the first intermediate mold 253, and the second intermediate mold 254.

In this state, a solid state sealing resin tablet is lowered from the opening part of the hollow cylindrical part 17 and is provided on the upper surface of the plunger 19 situated in the lower mold fixing part 6.

After that, mold closing is performed by contacting the upper mold 251 fixed to the upper mold fixing part 5 with the second intermediate mold 254. Then, mold clamping is performed with a designated pressure.

After mold clamping is performed, as shown in FIG. 31, the column parts 301 are pushed by the molds 251 through 254 so that the ejector pin supporting parts 302 where the eject pins 300 and the column parts 301 are supported and fixed are pressed and the eject pins 300 are operated in a body. As a are result of this, the compression springs 303 are compressed and the eject pins 300 move in a direction opposite to the cavity forming parts 260 through 262, namely inside of the molds 251 through 254 where the eject pins 300 are provided.

The first intermediate mold 253 and the second intermediate mold 254 are heated at a designated temperature by a heating mechanism (not illustrated) so that the entire mold 250 for resin sealing has an even temperature. Because of this, the solid state sealing resin tablet 40 supplied on the upper surface of the plunger 19 is melted. It is possible to make the flow properties at the time when the molten resin flows in the cavity forming parts 260 through 262 stable, by heating the first intermediate mold 253 and the second intermediate mold 254 at a designated temperature. In addition, it is possible to reduce a cycle time when the entire sealing operations are continuously performed.

Next, the plungers 19 having the upper surface where the molten resin 40 is provided go up in a vertical direction by the driving part not shown.

As a result of this, the molten resin is supplied from the upper part opening hole of the hollow cylindrical part 1, namely the opening surface of the pot part 18 to the second intermediate mold runner part 267 via the cull part 265 formed in the lower surface of the upper mold 251 and the upper mold runner part 266 in communication with the cull part 265. In addition, the molten resin is supplied to the cavity forming part 262 in the horizontal direction via the gate part 268 of the second intermediate mold runner 267 and flows in the second intermediate mold piercing runner part 269. Furthermore, the molten resin is supplied to the cavity forming part 261 in the horizontal direction via the gate part 271 of the first intermediate mold runner 270 in communication with the second intermediate mold piercing runner part 269 and flows in the first intermediate mold piercing runner part 272. Furthermore, the molten resin is supplied to the cavity forming part 260 in the horizontal direction via the gate part 274 of the lower mold runner 273 in communication with the first intermediate mold piercing runner part 272.

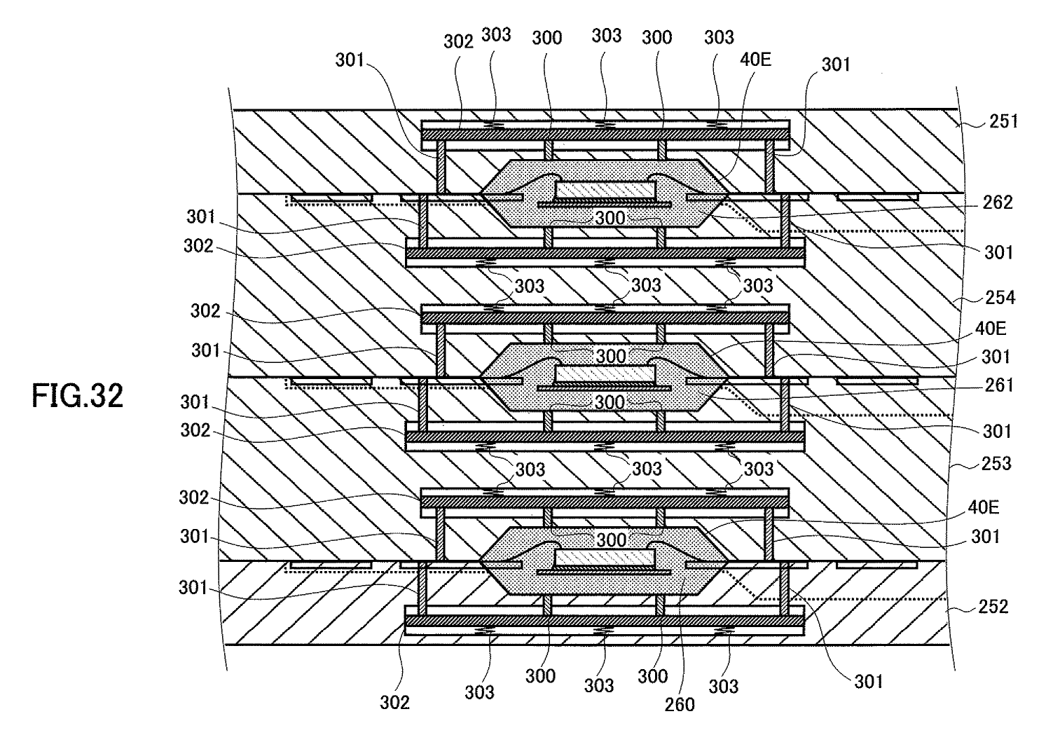

As a result of this, as shown in FIG. 32, the semiconductor elements 12 mounted on the die pad (die stage) 201 of the lead frame 200, the inner lead part 202, and the bonding wires connecting the semiconductor elements 12 and the inner lead part 202 are dipped in the sealing resin 40E in the cavity forming parts 260 through 262. Thus, resin is provided on both the surfaces of the lead frame 200.

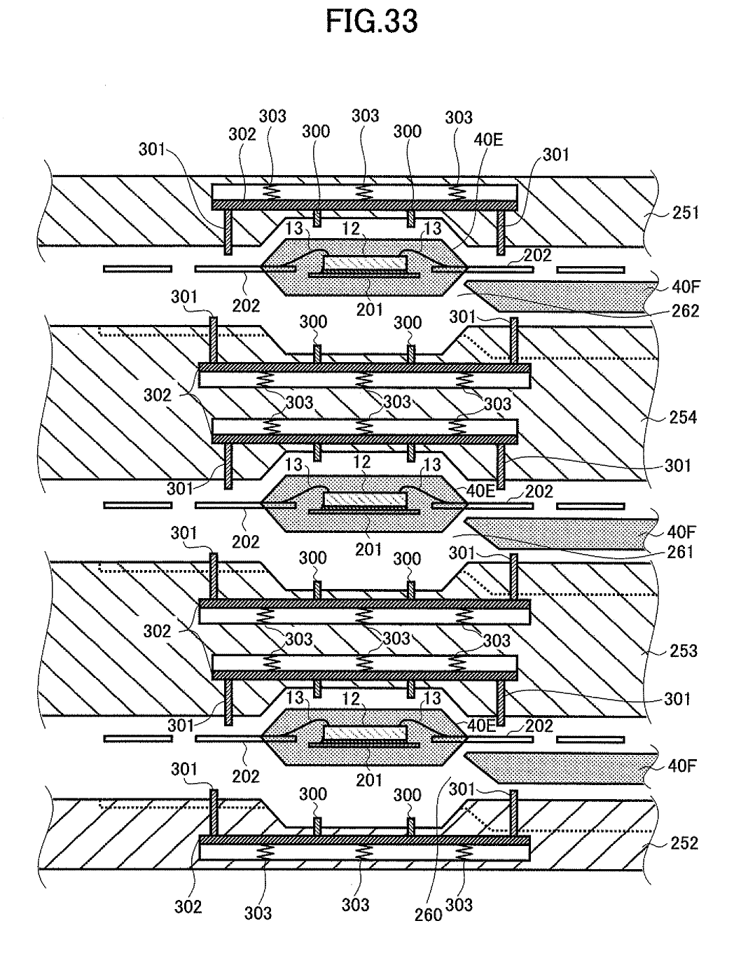

After resin sealing is completed, as shown in FIG. 33, mold opening is done so that the lead frame 200 having a main surface where plural semiconductors 12 and the bonding wires 13 are provided and a rear surface are sealed is taken out from the mold 250 for sealing resin.

At this time, not only the sealing resin 40E in the cavity forming parts 260 through 262 but also sealing resin 40F filling in the cull part 265, the upper mold runner part 266, the second intermediate mold runner 267, the gate part 268, the second intermediate mold piercing runner part 269, the first intermediate mold piercing runner part 272, the first intermediate mold runner 270, the gate part 271, the lower mold runner 273, and the gate part 274 are solidified.

In this step, the hollow cylindrical part 17 having the upper surface situated in the same position of the upper surface of the second intermediate mold 254 is lowered in the vertical direction by the driving part (not shown). Furthermore, the plunger 19 is lowered down in the vertical direction by the driving part (not shown).

Next, mold opening is performed so that the upper mold 251, the first intermediate mold 253, the second intermediate mold 254, and the lower mold 252 are released. More specifically, the first intermediate mold 253 and the second intermediate mold 254 are released from the mold 250 for resin sealing.

As a result of this, contact between the lower surface of the upper mold 251 and the upper surface of the second intermediate mold 254, contact between the lower surface of the second intermediate mold 254 and the upper surface of the first intermediate mold 253, and contact between the lower surface of the first intermediate mold 253 and the upper surface of the lower mold 252 are broken. The column parts 301 situated inside the molds 251 through 254 project from the surfaces of the molds 251 through 254 based on elastic force of the compression springs 303, so that the ejector pin supporting parts 302 and the eject pins 300 are operated in a body and project from the cavity forming parts 260 through 262. As a result of this, it is possible to take out the lead frames 200 where a surface having the semiconductor elements 12 and the bonding wires 13 and an opposite surface are sealed by resin, from the mold 250. It is general practice that a plating process is applied to the lead frame 200. Hence, it is possible to easily take out the sealing resin 40F filling in the second intermediate mold 267, the gate part 268, the first intermediate mold runner part 270, the gate part 271, the lower mold runner part 273 and the gate part 274.

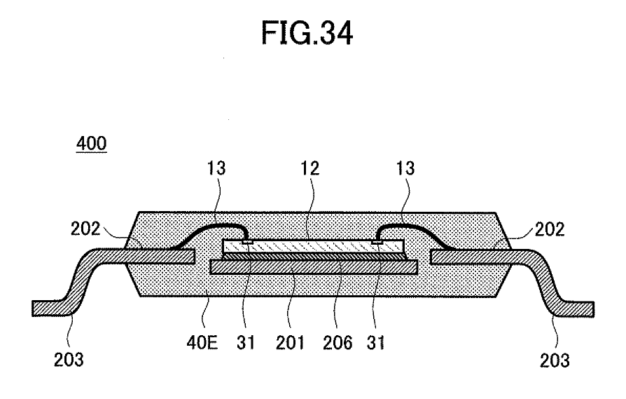

After the lead frames 200, a surface having the semiconductor elements 12 and the bonding wires 13, and an opposite surface are sealed by resin in a body, the outer lead parts 203 are cut and bent. As a result of this, the semiconductor device 400 (see FIG. 34) having the following structure is formed. That is, the semiconductor elements 12 provided on the die pad (die stage) are connected to the inner lead parts 202 by the bonding wires 13. The inner lead parts 202, the semiconductor elements 12, and the bonding wires 13 are sealed by sealing resin 40E. The outer lead parts 203 extend from the inner lead parts 202 outside of the sealing resin 40E.

Thus, in the fifth embodiment of the present invention, the surface of the lead frames 200 where the semiconductor elements 12 and the bonding wires 13 are provided and the opposite surface of the lead frames 200 are provided in the cavity forming parts 260 through 262. The molten resin is supplied from the pot part 18 as a single resin supplying source to the cavity forming parts 260 through 262 via a resin path formed by the cull part 265, the upper mold runner parts 266, the second intermediate mold 254, the gate parts 268, the second intermediate mold piercing runner parts 269, the first intermediate mold piercing runner parts 272, the first intermediate mold runner parts 270, the gate parts 271, the lower mold runner parts 273, and the gate parts 274.

The lead frames 200 are provided on the second intermediate mold 254, the first intermediate mold 253, and the lower mold 252. The part of the lead frame 200 where the semiconductor elements 12 and the bonding wires 13 are provided and the opposite part of the lead frame 200 are sealed at the same time.

Accordingly, manufacturing efficiency in the resin sealing step can be improved with a simple structure and without making the sizes of the upper mold 251 and the lower mold 252 large, namely without increasing the manufacturing cost.

In addition, in this embodiment as well as the second embodiment of the present invention, the molten resin may be independently supplied to each of the stacked molds.

Although the invention has been described with respect to specific embodiment for a complete and clear disclosure, the appended claims are not to be thus limited but are to be construed as embodying all modifications and alternative constructions that may occur to one skilled in the art that fairly fall within the basic teachings herein set forth.

For example, in each of the above-discussed embodiments of the present invention, components of the cavity forming parts and the runner parts of the molds may be made of sintered hard alloys and other components of the molds may be made of carbon tool steel (SKS93, SK4, SK5 or the like), martensitic stainless steel (SUS440C), or the like.

This patent application is based on Japanese Priority Patent Application No. 2007-71619 filed on Mar. 19, 2007, the entire contents of which are hereby incorporated herein by reference.

What is claimed is:

1. A resin sealing method comprising the steps of:
providing an intermediate mold between an upper mold and a lower mold, the intermediate mold having a cavity forming part where a resin sealed part is received; and
introducing sealing resin into the cavity forming part of the intermediate mold and another main surface of the intermediate mold via a runner, the runner being provided in a vicinity of the cavity forming part of the intermediate mold and piercing the intermediate mold in a thickness direction.

2. The resin sealing method as claimed in claim 1,
wherein a cavity forming part is provided in a surface of the lower mold facing the intermediate mold; and
the resin sealed part is received in the cavity forming part of the lower mold.

3. The resin sealing method as claimed in claim 1,
wherein the cavity forming parts are formed in an upper surface and a lower surface of the intermediate mold.

4. The resin sealing method as claimed in claim 3,
wherein the cavity forming parts formed in the upper surface and the lower surface of the intermediate mold have different configurations.

5. The resin sealing method as claimed in claim 3,
wherein the sealing resin is supplied from a single resin supplying source to the plural cavity forming parts.

6. The resin sealing method as claimed in claim 3,
wherein the sealing resin is independently supplied to the plural cavity forming parts.

7. The resin sealing method as claimed in claim 1,
wherein the intermediate mold is heated at a designated temperature at the time of mold clamping.

8. A resin sealing method comprising the steps of:
providing a plurality of the intermediate molds between an upper mold and a lower mold, the intermediate molds having cavity forming parts where resin sealed parts are received; and
introducing sealing resin into the cavity forming part of each of the intermediate molds via a runner, the runner being provided in the vicinities of the cavity forming parts of the stacked intermediate molds and piercing the intermediate molds in a stacking direction.

9. The resin sealing method as claimed in claim 8,
wherein the sealing resin is supplied from a single resin supplying source to the plural cavity forming parts.

10. The resin sealing method as claimed in claim 8,
wherein the sealing resin is independently supplied to the plural cavity forming parts.

11. The resin sealing method as claimed in claim 8,
wherein each of the plural cavity forming parts has a different configuration.

12. A mold for resin sealing, comprising:
an upper mold;
a lower mold; and
at least one intermediate mold provided between the upper mold and the lower mold;
wherein the intermediate mold includes
a cavity forming part formed in at least one of main surfaces of the intermediate mold and configured to receive a resin sealed part; and
a runner provided in the vicinity of the cavity forming part and piercing the intermediate mold in a thickness direction.

13. The mold for resin sealing as claimed in claim 12,
wherein plurality of the intermediate molds are stacked; and
the sealing resin is supplied from a single resin supplying source to plural of the cavity forming parts.

14. The mold for resin sealing as claimed in claim 12,
wherein plural of the intermediate molds are stacked; and
the sealing resin is independently supplied to plural of the cavity forming parts.

15. The mold for resin sealing as claimed in claim 14,
wherein each of plural of the cavity forming parts has a different configuration.

16. The mold for resin sealing as claimed in claim 12,
wherein plural of the cavity forming parts are formed in an upper surface and a lower surface of the intermediate mold.

17. The mold for resin sealing as claimed in claim 16,
wherein plural of the cavity forming parts formed in an upper surface and a lower surface of the intermediate mold have different configurations.

18. A resin sealing apparatus, comprising:
an upper mold;
a lower mold; and
at least one intermediate mold provided between the upper mold and the lower mold;
wherein the intermediate mold includes
a cavity forming part formed in at least one of main surfaces of the intermediate mold and configured to receive a resin sealed part; and
a runner provided in the vicinity of the cavity forming part and piercing the intermediate mold in a thickness direction.

19. The resin sealing apparatus as claimed in claim 18, further comprising:
a heating part configured to heat the intermediate mold at a designated temperature at the time of mold clamping.
